(19) United States
(12) Patent Application Publication
(10) Pub. No.: US 2001/0025212 A1
(43) Pub. Date: Sep. 27, 2001

(54) Fast resonance shifting as a way to reduce propellant for space mission applications

(76) Inventor: Edward A. Belbruno, Princeton, NJ (US)

Correspondence Address: HALE & DORR LLP, THE WILLARD OFFICE BUILDING, 1455 PENNSYLVANIA AVE, NW, WASHINGTON, DC, 20004, US

(21) Appl. No.: 09/726,388

(22) Filed: Dec. 1, 2000

Related U.S. Application Data
(63) Continuation-in-part of application No. PCT/US99/12213, filed on Jun. 2, 1998.
(60) Provisional application No. 60/087,636, filed on Jun. 2, 1998.
(60) Provisional application No. 60/048,244, filed on Jun. 2, 1997.
(60) Provisional application No. 60/036,864, filed on Feb. 4, 1997.
(60) Provisional application No. 60/041,465, filed on Mar. 25, 1997.
(60) Provisional application No. 60/044,318, filed on Apr. 24, 1997.

(51) Int. Cl. G06F 17/00

(52) U.S. Cl. 701/13; 244/161

(57) ABSTRACT

A method of changing at least one of an inclination and an altitude of a first object including at least one of a space vehicle, satellite and rocket, uses a computer implemented and assisted process. The method includes the sequential or non-sequential steps of generating a first transfer for convergence of first target variables at a first target including at least one of a first planet, first planet orbit and first location in space, and traveling, by the first object, to a vicinity of the first target using the first transfer. The method also includes rendezvousing, by the first object, with the first target where a second object including at least one of a second object, second planet, spaceship and comet, has undergone, is undergoing or will undergo a resonant hop or other resonance. The method also includes the steps of optionally performing an inclination change at the second object responsive to the second object undergoing the resonant hop or other resonance, and traveling from the second object to a third target.

### RELATED APPLICATIONS

This patent application claims priority from U.S. provisional patent application Ser. No. 60/087,636 filed Jun. 2, 1998 which is incorporated herein by reference, including all references cited therein.

This application is related to U.S. Provisional Patent application Ser. No. 60/048,244 filed Jun. 2, 1997, U.S. provisional patent application Ser. No. 60/036,864, filed Feb. 4, 1997, U.S. provisional patent application Ser. No. 60/041,465, filed Mar. 25, 1997, and U.S. provisional patent application Ser. No. 60/044,318 filed Apr. 24, 1997, all to inventor Edward A. Belbruno, and all of which are incorporated herein by reference, including all references cited therein.

This patent application is also related to PCT Patent Application PCT/US98/01924, filed Feb. 4, 1998, PCT Patent Application PCT/US98/05784, filed Mar. 25, 1998, PCT Patent Application PCT/US98/08247, filed Apr. 24, 1998, and corresponding U.S. national stage applications, 09/277,743, filed Mar. 29, 1999, 09/304,265, filed May 6, 1999, and 09/306,793, filed May 7, 1999, all to inventor Edward A. Belbruno, and all of which are incorporated herein by reference, including all references cited therein.

### FIELD OF THE INVENTION

This invention relates in general to methods for space travel, and in particular, to methods for an object, such as a satellite, space craft, and the like, to change inclinations using, for example, weak stability boundaries (WSBs) to be placed in orbit around the earth, moon, and/or other planets.

### BACKGROUND OF THE RELATED ART

The study of motion of objects, including celestial objects, originated, in part, with Newtonian mechanics. During the eighteenth and nineteenth centuries, Newtonian mechanics, using a law of motion described by acceleration provided an orderly and useful framework to solve most of the celestial me- chanical problems of interest for that time. In order to specify the initial state of a Newtonian system, the velocities and positions of each particle must be specified.

However, in the mid-nineteenth century, Hamilton recast the formulation of dynamical systems by introducing the so-called Hamiltonian function, H, which represents the total energy of the system expressed in terms of the position and momentum, which is a first-order differential equation description.

This first order aspect of the Hamiltonian, which represents a universal formalism for modeling dynamical systems in physics, implies a determinism for classical systems, as well as a link to quantum mechanics.

By the early 1900s, Poincare understood that the classical Newtonian three-body problem gave rise to a complicated set of dynamics that was very sensitive to dependence on initial conditions, which today is referred to as “chaos theory.” The origin of chaotic motion can be traced back to classical (Hamiltonian) mechanics which is the foundation of (modern) classical physics. In particular, it was nonintegrable Hamiltonian mechanics and the associated nonlinear problems which posed both the dilemma and ultimately the insight into the occurrence of randomness and unpredictability in apparently completely deterministic systems.

The advent of the computer provided the tools which were hitherto lacking to earlier researchers, such as Poincare, and which relegated the nonintegrable Hamiltonian mechanics from the mainstream of physics research. With the development of computational methodology combined with deep intuitive insights, the early 1960s gave rise to the formulation of the KAM theorem, named after A. N. Kolmogorov, V. I. Arnold, and J. Moser, that provided the conditions for randomness and unpredictability for nearly non-integrable Hamiltonian systems.

Within the framework of current thinking, almost synonymous with certain classes of nonlinear problems is the so-called chaotic behavior. Chaos is not just simply disorder, but rather an order without periodicity. An interesting and revealing aspect of chaotic behavior is that it can appear random when the generating algorithms are finite, as described by the so-called logistic equations.

Chaotic motion is important for astrophysical (orbital) problems in particular, simply because very often within generally chaotic domains, patterns of ordered motion can be interspersed with chaotic activity at smaller scales. Because of the scale characteristics, the key element is to achieve sufficiently high resolving power in the numerical computation in order to describe precisely the quantitative behavior that can reveal certain types of chaotic activity. Such precision is required because instead of the much more familiar spatial or temporal periodicity, a type of scale invariance manifests itself. This scale invariance, discovered by Feigenbaum for one-dimensional mappings, provided for the possibility of analyzing renormalization group considerations within chaotic transitions.

Insights into stochastic mechanics have also been derived from related developments in nonlinear analysis, such as the relationship between nonlinear dynamics and modern ergodic theory. For example, if time averages along a trajectory on an energy surface are equal to the ensemble averages over the entire energy surface, a system is said to be ergodic on its energy surface. In the case of classical systems, randomness is closely related to ergodicity. When characterizing attractors in dissipative systems, similarities to ergodic behavior are encountered.

An example of a system's inherent randomness is the work of E. N. Lorenz on thermal convection, which demonstrated that completely deterministic systems of three ordinary differential equations underwent irregular fluctuations. Such bounded, nonperiodic solutions which are unstable can introduce turbulence, and hence the appellation “chaos,” which connotes the apparent random motion of some mappings. One test that can be used to distinguish chaos from true randomness is through invocation of algorithmic complexity; a random sequence of zeros and ones can only be reproduced by copying the entire sequence, i.e., periodicity is of no assistance.

The Hamiltonian formulation seeks to describe motion in terms of first-order equations of motion. The usefulness of the Hamiltonian viewpoint lies in providing a framework for the theoretical extensions into many physical models, foremost among which is celestial mechanics. Hamiltonian equations hold for both special and general relativity. Furthermore, within classical mechanics it forms the basis for further development, such as the familiar Hamilton-Jacobi method and, of even greater extension, the basis for perturbation methods. This latter aspect of Hamiltonian theory will provide a starting point for the analytical discussions to follow in this brief outline.

Since the first lunar missions in the 1960s, the moon has been the object of interest of both scientific research and potential commercial development. During the 1980s, several lunar missions were launched by national space agencies. Interest in the moon is increasing with the advent of the multi-national space station making it possible to stage lunar missions from low earth orbit. However, continued interest in the moon and the feasibility of a lunar base will depend, in part, on the ability to schedule frequent and economical lunar missions.

A typical lunar mission comprises the following steps. Initially, a spacecraft is launched from earth or low earth orbit with sufficient impulse per unit mass, or change in velocity, to place the spacecraft into an earth-to-moon orbit. Generally, this orbit is a substantially elliptic earth-relative orbit having an apogee selected to nearly match the radius of the moon's earth-relative orbit.

As the spacecraft approaches the moon, a change in velocity is provided to transfer the spacecraft from the earth-to-moon orbit to a moon-relative orbit. An additional change in velocity may then be provided to transfer the spacecraft from the moon-relative orbit to the moon's surface if a moon landing is planned. When a return trip to the earth is desired, another change in velocity is provided which is sufficient to insert the spacecraft into a moon-to-earth orbit, for example, an orbit similar to the earth-to-moon orbit. Finally, as the spacecraft approaches the earth, a change in velocity is required to transfer the spacecraft from the moon-to-earth orbit to a low earth orbit or an earth return trajectory.

FIG. 1 is an illustration of another conventional orbital system, described in U.S. Pat. No. 5,158,249 to Uphoff, incorporated herein by reference, including the references cited therein. The orbital system 28 comprises a plurality of earth-relative orbits, where transfer between them is accomplished by using the moon's gravitational field. The moon's gravitation field is used by targeting, through relatively small mid-orbit changes in velocity, for lunar swingby conditions which yield the desired orbit.

Although the earth-relative orbits in the orbital system 28 may be selected so that they all have the same Jacobian constant, thus indicating that the transfers between them can be achieved with no propellant-supplied change in velocity in the nominal case, relatively small propellant-supplied changes in velocity may be required. Propellant-supplied changes in velocity may be required to correct for targeting errors at previous lunar swingbys, to choose between alternative orbits achievable at a given swingby, and to account for changes in Jacobian constant due to the eccentricity of the moon's earth-relative orbit 36.

In FIG. 1, a spacecraft is launched from earth 16 or low earth orbit into an earth-to-moon orbit 22. The earth-to-moon orbit 22 may comprise, for example, a near minimal energy earth-to-moon trajectory, for example, an orbit having an apogee distance that nearly matches the moon's earth-relative orbit 36 radius. The spacecraft encounters the moon's sphere of gravitational influence 30 and uses the moon's gravitational field to transfer to a first earth-relative orbit 32.

The first earth-relative orbit 32 comprises, for example, approximately one-half revolution of a substantially one lunar month near circular orbit which has a semi-major axis and eccentricity substantially the same as the moon's earth-relative orbit 36, which is inclined approximately 46.3 degrees relative to the plane defined by the moon's earth-relative orbit 36, and which originates and terminates within the moon's sphere of influence 30. Because the first earth-relative orbit 32 and a typical near minimum energy earth-to-moon orbit 22 have the same Jacobian constant, the transfer can be accomplished by using the moon's gravitational field.

FIG. 2 is an illustration of another conventional lunar gravitational assistance transfer principle. In FIG. 2, the satellite is firstly transferred onto a standard orbit 01 situated inside a quasi-equatorial plane, which, in practice, known as a Geostationary Transfer Orbit (GTO) orbit. At T1, the satellite is transferred onto a circumlunar orbit 02, still situated in the quasi-equatorial plane.

In practice, an extremely elliptic orbit is selected whose major axis is close to twice the Earth/Moon distance, namely about 768,800 km. The satellite penetrates into the sphere of influence SI of the moon and leaves this sphere on a trajectory 03 whose plane is highly inclined with respect to the equatorial plane. At T2, the satellite is injected onto the definitive orbit 04 inside the same plane as the orbit 03. The above described orbital system is described in detail in U.S. Pat. No. 5,507,454 to Dulck, incorporated herein by reference, including the references cited therein.

Dulck attempts to minimize the thrusters needed, where the standard technique of lunar gravity assist is used. The satellite is first brought to a neighborhood of the moon by a Hohmann transfer. It then flies by the moon in just the right directions and velocities, where it is broken up into two or more maneuvers. This method works, but the size of this maneuver restricts the applications of the method to ellipses whose eccentricities are sufficiently large. This is because to have a savings with this large maneuver, the final maneuver needs to be sufficiently small.

In 1988 another chaotic instability was discovered by means of computer investigations in the three-body problem for the elliptic motion of a particle of negligible mass about the earth whose motion is perturbed by the moon[11]. Unlike Arnold diffusion, it is extremely fast taking only days. It is called the hop. It takes place between resonance ellipses about the earth with the moon. A particle moving one of these ellipses when passing near the moon in a special region can dramatically shift from one ellipse to another.

Until 1995 there was no way to prove that the hop was a real motion, and not just a computer artifact. This changed in April 1995 when it was brought to my attention by Brian Marsden in New York at the International NEO Conference that the comet Oterma was shown to rapidly pass between two different resonances with Jupiter about the sun by passing near Jupiter. Marsden, B. G., “The Orbit and Ephemeris of Periodic Comet Oterma”, Astron. J., v66, 246-248, 1951. Since then, it has been verified that Oterma as well as nine other comets are performing the hop. Thus, the hop is a verifiable process, and causes dramatic effects in the way some comets move about the sun. It is natural to ask if other objects in the solar system are performing this dynamics. For example, many of the newly discovered Kuiper belt objects seem to be in resonance with Neptune, and could therefore rapidly shift to a different resonance ellipse by passing near to Neptune.

When an object transitions from one resonance ellipse to another it does so in a special region where sensitive or chaotic dynamics occurs about the secondary planet, and is referred to as the fuzzy boundary (fb). Mathematically speaking it is conjectured to be a so called hyperbolic tangle. A tangle is an infinitely complex structure where the motion is unstable and first hypothesized in general to exist by Pointcaré. In the lunar case, the fb surrounds the moon and extends out to a maximal distance. An object moving there is in near escape with the Moon and has no central body, i.e. the earth or moon. It is captured temporarily and is very weakly gravitationally bound. This is called weak capture.

The idea of weak capture originally defined in 1986 was motivated by the work of Mather on the nonexistence of certain types of motions. Mather, J. N., “A Criterion for the Non-Existence of Invariant Circles”, Publ. Math. IHES, v63, 153-204, 1982.

An interesting dynamic occurs in the three-body problem between the earth-moon-particle. Here a particle is captured from infinity by the moon and falls into a sequence of 8 sets of hops about the Earth. It then escapes the earth-moon system. This entire process of capture-hopping-escape is only 3000 days. A process like this is important because it provides a mechanism for a particle to become captured into the earth-moon system and then acquire enough energy to escape in a very short period of time. The mechanism of Arnold diffusion would yield estimates of many millions of years for this to occur. The process of capture and escape through transient resonant motion provides a tool to understand the global dynamics.

If the sun is included as a gravitational perturbation, then a capture-escape trajectory with respect to the earth-moon system can also be found, and the duration is reduced to 450 days with only 3 hops.

The reason an object would suddenly transition from one resonance to another resonance after weak capture is not understood. A mathematical proof of the existence of the hop may involve the deep results of Mather on dynamics which are far from integrable. Mather, J. N., “Variational Construction of Connecting Orbits”, Ann. Inst. Fourier, Grenoble, v43, no.5, 1349-1386, 1993; Mather, J. N., “A Criterion for the Non-Existence of Invariant Circles”, Publ. Math. IHES, v63, 153-204, 1982.

The significance of the fb and weak lunar capture was underscored in 1990 when a low energy transfer from the earth to the moon was found for the Japanese spacecraft Hiten by Belbruno using a method developed in 1986. Belbruno, E.; Miller, J., “Sun-Perturbed Earth-to-Moon Transfers with Ballistic Capture”, J. Guid., Control and Dyn., v16, 73-80, 1993; Belbruno, E., “Lunar Capture Orbits, A Method of Constructing Earth-Moon Trajectories and the Lunar GAS Mission”, Proceedings 19th AIAA/DGLR/JSASS Inter. Elec. Propl. Conf., AIAA Paper no. 87-1054, Col. Springs, May 1987. 87-1054.

This transfer was used by Hiten in 1991 which enabled it to arrive at the moon in October of that year. Belbruno, E., “Ballistic Lunar Capture Transfers using the Fuzzy Boundary and Solar Perturbations: A Survey”, J. Brit. Inter. Soc., v47, 73-80, 1994; Belbruno, E.; Miller, J., “Sun-Perturbed Earth-to-Moon Transfers with Ballistic Capture”, J. Guid., Control and Dyn., v16, 73-80, 1993; Belbruno, E., “Examples of the Nonlinear Dynamics of Ballistic Capture and Escape in the Earth-Moon System”, Proc. AIAA Conf. on Astrodynamics, AIAA Paper no. 90-2896, August 1990.

Fast resonance shifting was initially reported in 1990, Belbruno, E., “Examples of the Nonlinear Dynamics of Ballistic Capture and Escape in the Earth-Moon System”, Proc. AIAA Conf. on Astrodynamics, AIAA Paper no. 90-2896, August 1990, using System (1) for n=2,3, i.e., the three and four-body problems, between E,M,p and E,M,S,p, respectively, using the DE403 ephemeris. Extended numerical integrations in forward and backward time in these two problems starting from weak lunar capture suggests the following general behavior, which we refer to as Capture-Hop-Escape (CHE) dynamics, p is initially hyperbolic and becomes captured into the E,M-system. It then performs a finite sequence of hops, and is ejected from the E,M-system in a finite period of time. CHE dynamics is conjectured to occur, in general, in the E,M-system starting from WC initial conditions at M.

DE403 can be replaced by uniform elliptic motion for EM,S. The differences between DE403 and uniform elliptic motion for the time spans considered here are numerically negligible as far as numerical integration is concerned, especially since p does not pass too close to E,M, or S. Following the nomenclature in the previous section for n=2, we have the E³ and PE³ problems between E,M,p for DE403 and uniform elliptic motion, respectively. Capture into the E,M-system at t=tₒ means that,

$${H}_{E} = \frac{1}{2} {\vert v \vert}^{2} - \frac{{Gm}_{1}}{\vert x \vert} < 0.$$

where x,v are the position and velocity, respectively, of p with respect to E. This is not necessarily weak capture. Ejection occurs when H_{E}>0 at a time t₁≠tₒ where t₁<tₒ or t₁>tₒ.

In the ejected states for n=2, it is found that |x| →∞as t→±∞. This property is not easy to achieve.

For n=3, although p eventually escapes E in forward and backward time, |x|_∞. This is because it has in general not escaped S. To escape S would be very difficult. Once p escaped the E,M-system, its energy is only slightly higher than the Kepler energy of E about S. Thus it is in a near E orbit about S. To escape S, p must repetitively return to near E and fly by it so as to pump up the energy with respect to S to decrease the periapsis so the particle can eventually fly by S where it is possible to increase the velocity of p enough to escape S as well. This process could take many millions of years.

The following nomenclature is used. If p escapes the E,M-system in forward and backward time from hopping, but it doesn't necessarily escape infinitely far from E in forward and backward time, as in the case of n=3, then the resulting trajectory is called a CHE trajectory, or a CHE, for brevity. If it is captured from infinitely far from E, and escapes infinitely far from E as in the case of n=2, then it is referred to as a bi-infinite CHE.

Two numerical examples are given illustrating a CHE for n=3, and a bi-infinite CHE for n=2. The figures for the first case are FIGS. 3A,B,C,D,E,F. The figures for the second case are FIGS. 4A,B,C,D,E,F,G; 5A,B,C,D,E,F,G; 6A,B,C,D.

For CHE, n=3, the sequence of events are, capture→7:3→2:1 escape. FIG. 3A shows the complete CHE. The coordinate system is centered at E, and S is near the negative x-axis when the integration is begun at the initial point labeled by o. The end point is labeled n. This is an inertial plot, where E,M,S are all in motion. Only x,y-plots are given for brevity, although there is significant out of plane motion. The start date at o is Mar. 27, 1987, and the end date is May 22, 1988, which is 422 days later. The trajectory starts hyperbolically at o, and after about 125 days it first moves close to L₁ and then L₂ to begin a sequence of hops. The distance of p to L₂ is shown in FIG. 3D where the x-axis is days from the initial date. FIG. 3B shows a blow up of what is going on after capture. The 7:3 motion is broken up into two elliptic bands indicated. Then the particle moves onto the 2:1 where it eventually escapes.

This resonant motion is verified by comparing FIGS. 3C,3E,3F. In FIG. 3C, the particle is seen moving near L₁ and L₂. It then moves onto the 7:3 which precesses in the fixed coordinate system. In this system, M is located on the x-axis at −1+μ units, where 1 unit equals the mean E,M distance of approximately 386,000 km and μ≅0.0123. The lobes indicate the portion of the 7:3 motion the particle is on, and they are consecutively numbered. After completing the seventh circuit about E, it moves onto a 2:1 which is labeled. FIG. 3E shows H_{E} is initially positive, then abruptly dropping indicating capture. From about 130 days to about 215 days the energy varies so as to be near the 7:3, and then jumps to the 2:1 energy value before escaping. FIG. 3F shows E_{M}. The 7:3, 2:1 break up into characteristic oscillatory peaks and valleys.

Bi-infinite CHE, n=2. The sequence of events are, capture →1:2(11)→1:2→7:3→1:2(9)→7:3→2:1(3)→4:5→2: 1(13)→escape. The ability of a particle to escape the E,M-system without the gravitational perturbation of S is more difficult, and a longer time is needed. Upon escaping, p can continue to move infinitely far from E. An example is documented here in which p moves infinitely far from E in forwards and backward time. While captured in the E,M-system, it performs a complex sequence of hops listed in the above sequence.

Most of the fixed coordinate system plots are not included, nor most of the plots for H_{M}. The initial investigations on a portion of this bi-infinite CHE were initially done in 1990 for the 2:1→4:5 shown in FIG. 4F. In 1995, the portion of the sequence from FIG. 4E to FIG. 4G was animated, showing the sequence 7:3→2:1(3)→4:5→2:1(13)→escape.

The entire sequence is shown in FIGS. 4A-4G. The start date for this example is Apr. 25, 1984, and it ends on Aug. 6, 1992. The particle starts hyperbolically as shown in FIG. 5A and ends hyperbolically shown in FIG. 5G, where approximately 3000 days have past.

This is briefly described. The figures shown have the respective dynamics; FIG. 4A, capture→1:2(5); FIG. 4B, 1:2(5); FIG. 4C, 1:2→1:2→7:3; FIG. 4D, 1:2(9); FIG. 4E, 7:3→2:1(2); FIG. 4F, 2:1→4:5(1.5); FIG. 4G, 4:5(1.5)→2:1(13) escape.

The plots of H_{E} are shown in FIGS. 5A-5G. They are labeled to indicate the resonances, in the same respective order as FIGS. 4A-4G for comparison. FIG. 4A shows the capture. Comparing this to FIG. 5A shows H_{E} abruptly ao from positive to negative. FIG. 5C gives a correlation with the dynamics in FIG. 4C. The escape is shown in FIG. 4G. Note how H_{E} is near zero in FIG. 5G. Corresponding to FIG. 5G is FIG. 6B showing H_{M}.

In order to escape the E,M-system with no near collisions, a very subtle energy pumping mechanism is required to gradually increase H_{E} from negative to positive, so that p not only escapes the E,M-system, but will move infinitely far away. This process is seen clearly in FIG. 5G where the energy of H_{E} is made to gradually increase in a stepwise fashion as t makes 13 revolutions about E on 1:2 ellipses. A tiny amount of energy increase is obtained as p flys by M. The brief interactions with M are shown in FIG. 6B.

It is remarked that as p moves from capture to escape, H_{E} stays relatively near to zero, in negative values. This is required so that the particle can have the necessary energy to be able to hop. It is seen that many cycles of p are required about E in order to gradually pump down the energy, as is seen in FIGS. 4A, 5A. The energy can't be pumped down too much or too little, otherwise p will not be able to start hopping. This dynamics is seen to be very delicately balanced, however, as is commented on later, numerically appears to be robust. This dynamics is nontrivial.

The plot of H_{M} in FIG. 6A shows a clear division of the different resonances. The corresponding plot of H_{E} is shown in FIG. 5C. The plot of FIG. 4C in a fixed coordinate system is shown in FIG. 6C. As with the discussion of FIG. 3C in Case A, the 7:3 in this example is indicated. During the hops from 1:2 to 1:2 and then to 7:3, note the complicated dynamics around M in the region of ST. This is magnified in FIG. 6D. This is an M centered fixed coordinate system. The two collinear Lagrange points, Lᵢ, i=1,2 on the x-axis are approximately d units from M,

d=(μ/3)^{⅓},

d˜16.

The particle is seen approaching near to L₁ on the upper left after had completed over one complete circuit about M on a 1:2 ellipse after leaving o. It then performs a complicated motion about M. It is performing a hop while on this motion. The trajectory is marked using a single arrow. Upon exiting, p passes near to L₁. It exits on a 1:2 ellipse also. Another circuit about M brings it back to near L₁ where it is now on the center left, where a double arrow is used to track it. It moves nonlinearly about M in another hop and exits near L₂ where it passes onto a 7:3. Returning near to L₂ after approximately three lunar periods, it passes near to L₂ again, being marked with three arrows, where it hops back to a 1:2.

This motion about M is typical to motion near a so called hyperbolic tangle which is explained in Section 6. The fact p exits enters and exits hops in resonances is suggested by the work of Mather described in the Section 6 also.

Understanding the ultimate fate of N bodies in the general N-body problem, N>2, under the inverse square Newtonian gravitational force law for an arbitrary set of initial conditions has been an outstanding problem in dynamics going back to Lagrange in the late 18th century. This is an enormously difficult problem, and qualitative results were started by Poincare using the planar restricted three-body problem, C², where p moves in the same plane as two primaries P₁, P₂ where the mass of P₁ is much larger than the mass of P₂. His results were obtained for periodic motions of p about P₁. One can imagine that P₁=S, P₂=J, and p is an asteroid. Of course, the motions in the C₂ or even C₃ problems don't have to be periodic. If p is given an initial position and velocity, in say the C₃ problem, it can move in many different ways.

Some of these motions are bounded, some are unbounded, some are oscillatory, recurrent, near collision, etc. Of fundamental interest are those solutions which become unbounded in phase space. Thought about in terms of position space this is a very difficult problem because the route to becoming unbounded can be extremely complicated, and very slow. p could wander all over the physical space and eventually make its way to infinity, or it may stay bounded.

Viewed in position space, Birkoff conjectured that in the general 3-body problem, the set of solutions tending to infinity were, in fact, dense and he indicated the possibility of this being true for N>3 as well. This is known as the Birkoff quasi-ergodic hypothesis or the Birkoff conjecture. We state it now in terms of the general phase space. As N-bodies are moving, the Hamiltonian energy H is conserved[31]. This yields a 6N-1 dimensional surface Σ={H(p, q)=c}, c ε [symbol] , where q ε [symbol] ^{3N}, p ε [symbol] ³ⁿ are the position and momentum variables. Let_ (x, t) be the flow associated with the Hamiltonian H on Σ obtained from the Hamiltonian differential equations,

$$\dot{q} = \frac{\partial H}{\partial p} , \dot{p} = \frac{- \partial H}{\partial q} ,$$

where x εΣ,_(t)=(q(t),p(t)).

The Birkoff conjecture asserts that the set of x εΣ such that_(x, t) becomes unbounded as t→±∞ is dense in Σ.

This is very difficult to answer since for a given set of initial conditions, _(t) may become trapped in an open region of the phase space thus disproving the conjecture. This is indeed the case for the C² problem which is described below, which is due to the fact that this problem has only two degrees of freedom. The mechanism of Arnold diffusion may allow _(t) to become unbounded, for a large set of initial conditions in the C³ or E³ problem, however very slowly as is described below. In fact, this mechanism is so slow, that numerical integrations used to verify it are prohibitively long.

In order to shed light on the Birkoff conjecture, a mechanism is needed which will allow _(t) to rapidly move between large regions of the phase space which may move near elliptic type motion.

The bi-infinite CHE for n=2, we refer to as Case B, described above for the ^{PE3} problem, and also the E³ problem, provides such a mechanism, which is numerically verifiable. This trajectory becomes unbounded as t→±∞. Numerical investigations show that Case B is robust under small perturbations. That is, under small perturbations another bi-infinite CHE is obtained where, in general, the sequence of hops are different. This yields an open tube TB in phase space about Case B all points of which become unbounded in forward and backward time. Thus, TB ⊂Σ provides an open region on Σ where the Birkoff conjecture is true.

The question of what happens to p in the C² problem if p starts its motion with elliptic initial conditions about S was ultimately solved by the celebrated KAM theorem, where KAM means Kolmogorov-Amold-Moser. Basically, p will move in a stable elliptic way, not varying much from the initial elliptic state, provided it does not move too close to resonance with P₂. It just keeps cycling around and around P1, and its orbital elements will almost be constant. That is, P₂ doesn't change things too much. Even when p moves in near resonance with P₂, the motion is also stable and the orbital elements change very little. However, under closer examination, p's elliptic orbit will have a very small chaotic character to it.

Geometrically what is going on is that p is moving on or near so called two-dimensional KAM tori in the four-dimensional phase space of position and velocity supporting quasi-periodic motion of two frequencies. When the motion is not too close to resonance, it moves on one of these tori. Otherwise, it moves in between them. In this case, it can not go very far because the KAM tori are dense and block the motion of p. They block the motion because as p moves, the energy H is a constant c. In suitable coordinates H depends on four variables—two position and two velocity. Thus, p moves on a so called energy surface H=c of three-dimensions. Since the tori are two-dimensional, concentric tori trap trajectories in between them. The C³ problem is not so clear.

In this case, p does not have to move on the P₁, P₂ orbital plane and moves in three dimensions with three position and three velocity coordinates. Thus H depends on six variables and H=c yields a five-dimensional surface. As p moves about P₁ in an ellipse whose elements don't change very much and which is sufficiently far from resonance with P₂, it is moving on a torus of three dimensions. However, since these tori are two dimensions less than the dimensions of the of the energy surface, motion off one of these tori is not blocked by neighboring tori. Thus, near resonant motion can drift away from its initial elliptic state.

This drifting is referred to as Arnold diffusion, and first proven to exist for a simpler problem in 1964. It is very slow because as p moves away from KAM tori it starts very close to them, and this keeps it in their neighborhood for long periods of time. It moves from torus to torus by passing near a complex set of hyperbolic invariant manifolds. These set of tori are referred to as a transition chain. p is actually moving in a region near the tori called a resonance zone where the three frequencies associated to the motion are not rationally independent. As an example, one can imagine that an asteroid moving about S under the perturbation of J, p will slowly become unstable due to motion in the resonance zone. These rates are estimated to be tens of millions of years.

Estimates by Nekoroshev and others for the C³ problem indicate that to move significant distances in physical space from the initial elliptic motion, that time spans on the order of 10¹⁰ years are required. This is because the rate of velocity of p is on the order of:

e^{-1/μ16}

where 0<k<1, μ is the mass ratio of the two primaries, μ=0.001I in the S,J-system. Typically, k=½. The time to span significant distances through the hop is on the order of 10¹ years. This factor is more relevant in the S,J-system where the mass ratio is fairly small, which is required for Arnold diffusion theory. In the E,M-system, μ=0.0123, and this may be a little too large.

I have determined, however, that all of the above orbital systems and/or methods suffer from the requirement of substantial fuel expenditure for maneuvers, and are therefore, not sufficiently efficient. I have also determined that the above methods focus on orbital systems that concentrate on the relationship between the earth and the moon, and do not consider possible effects and/or uses beyond this two-body problem.

Accordingly, it is desirable to provide an orbital system and/or method that furnishes efficient use of fuel or propellant. It is also desirable to provide an orbital system and/or method that it not substantially dependent on significant thrusting or propelling forces.

It is also desirable to provide an orbital system and/or method that considers the effects of resonant hopping to facilitate the efficient use of fuel or propellant. It is also desirable to provide an orbital system and/or method that may be implemented on a computer system that is either onboard the spacecraft or satellite, or located in a central controlling area.

It is also desirable to provide an orbital system and/or method that is sustainable with relatively low propellant requirements, thereby providing an efficient method for cislunar travel. It is also desirable to provide an orbital system and/or method that does not require large propellant supplied changes in velocity. It is also desirable to provide an orbital system and/or method that renders practical massive spacecraft components. It is also desirable to provide an orbital system and/or method that may be used for manned and unmanned missions.

It is also desirable to provide an orbital system and/or method that allows a spacecraft or satellite to make repeated close approaches at various inclinations to both the earth and moon. It is also desirable to provide an orbital system and/or method that allows a spacecraft or satellite to make inclination changes with respect to, for example, the earth and/or moon.

### SUMMARY OF THE INVENTION

It is a feature and advantage of the present invention to provide an orbital system and/or method that furnishes efficient use of fuel or propellant.

It is another feature and advantage of the present invention to provide an orbital system and/or method that it not substantially dependent on significant thrusting or propelling forces.

It is another feature and advantage of the present invention to provide an orbital system and/or method that considers the effects of resonant hopping to facilitate the efficient use of fuel or propellant.

It is another feature and advantage of the present invention to provide an orbital system and/or method that may be implemented on a computer system that is either onboard the spacecraft or satellite, or located in a central controlling area.

It is another feature and advantage of the present invention to provide an orbital system and/or method that is sustainable with relatively low propellant requirements, thereby providing an efficient method for cislunar travel or travel to other planets.

It is another feature and advantage of the present invention to provide an orbital system and/or method that does not require large propellant supplied changes in velocity.

It is another feature and advantage of the present invention to provide an orbital system and/or method that renders practical massive spacecraft components.

It is another feature and advantage of the present invention to provide an orbital system and/or method that may be used for manned and unmanned missions.

It is another feature and advantage of the present invention to provide an orbital system and/or method that allows a spacecraft or satellite to make repeated close approaches at various inclinations to both the earth and moon.

It is another feature and advantage of the present invention to provide an orbital system and/or method that allows a spacecraft or satellite to make inclination changes with respect to, for example, the earth and/or moon.

The present invention comprises a system and/or method which substantially reduces the propellant requirements for space missions by considering the effects of resonant hopping to facilitate the efficient use of fuel or propellant. The present invention also provides orbital systems useful for planet-to-planet travel, which do not directly utilize the moon's gravitational field to achieve orbital transfers and can be sustained with relatively low propellant requirements. The present invention further provides frequent earth return possibilities for equipment and personnel on the moon, or in a moon-relative orbit or other planet or planetary orbit. The present invention also provides orbital systems useful for earth-to-moon, earth-to-earth orbit, moon-to-earth/earth orbit, and/or interplanetary travel, which the effects of resonant hopping to facilitate the efficient use of fuel or propellant for orbit entry and/or inclination changes to achieve orbital transfers and can be sustained with relatively low propellant requirements.

The present invention is based, in part, on my discovery that the conventional methods and/or orbital systems that concentrate or revolve around the relationship between the earth and the moon, and do not consider possible effects and/or uses beyond this two-body problem. More specifically, I have determined a new method and system that considers orbital capture, lunar travel and/or interplanetary travel utilizing the effects of resonant hopping to facilitate the efficient use of fuel or propellant.

In accordance with one embodiment of the invention, a method of changing at least one of an inclination and an altitude of a first object including at least one of a space vehicle, satellite and rocket, uses a computer implemented and assisted process. The method includes the sequential or non-sequential steps of generating a first transfer for convergence of first target variables at a first target including at least one of a first planet, first planet orbit and first location in space, and traveling, by the first object, to a vicinity of the first target using the first transfer. The method also includes rendezvousing, by the first object, with the first target where a second object including at least one of a second object, second planet, spaceship and comet, has undergone, is undergoing or will undergo a resonant hop or other resonance. The method also includes the steps of optionally performing an inclination change at the second object responsive to the second object undergoing the resonant hop or other resonance, and traveling from the second object to a third target including at least one of a third planet, third planet orbit and third location in space, at a predetermined arbitrary altitude and an optional inclination.

The above method may be stored on a compute memory, and implemented, fully or in part by a computer with the optional assistance of a user. The method may be further used for capture, ejection and/or interplanetary space travel.

There has thus been outlined, rather broadly, the more important features of the invention in order that the detailed description thereof that follows may be better understood, and in order that the present contribution to the art may be better appreciated. There are, of course, additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

FIG. 1 is an illustration of a conventional orbital system, described in U.S. Pat. No. 5,158,249;

FIG. 2 is an illustration of a conventional lunar gravitational assistance transfer principle;

FIGS. 3A-3F, 4A-4G, 5A-5G, and 6A-6D are illustrations of two numerical examples for a CHE where n=3, and a bi-infinite CHE where n=2;

FIG. 7 is an illustration of a plot of Geherls 3 comet which is initially on a 2:3 ellipse, and after weak capture is on a 3:2 ellipse;

FIGS. 8A-8C are illustrations showing typical behavior during a hop for the comet 74P/Smirnova-Chernykh;

FIG. 9 is an illustration of a weak stability boundary (WSB) and hop transition for a complex out- of-plane oscillation, resulting in three lunar flybys;

FIG. 10 is an illustration of an object SC transferring to rendezvous with SO from a distant starting point p, using the resonant hop on a Hohmann transfer;

FIG. 11 is an illustration of main central processing unit for implementing the computer processing in accordance with one embodiment of the present invention;

FIG. 12 is a block diagram of the internal hardware of the computer illustrated in FIG. 11; and

FIG. 13 is an illustration of an exemplary memory medium which can be used with disk drives illustrated in FIG. 11.

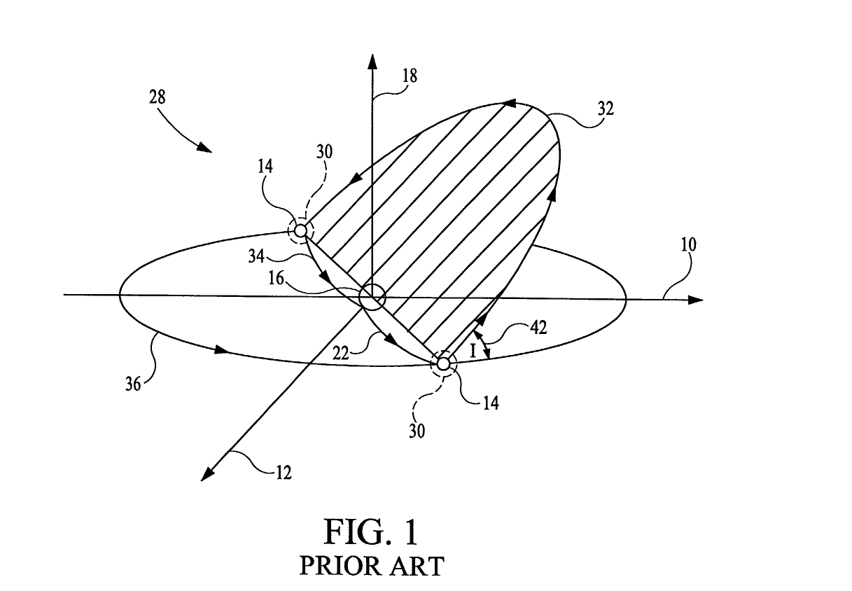

Notations and Nomenclature

The detailed descriptions which follow may be presented in terms of program procedures executed on a computer or network of computers. These procedural descriptions and representations are the means used by those skilled in the art to most effectively convey the substance of their work to others skilled in the art.

A procedure is here, and generally, conceived to be a self-consistent sequence of steps leading to a desired result. These steps are those requiring physical manipulations of physical quantities. Usually, though not necessarily, these quantities take the form of electrical or magnetic signals capable of being stored, transferred, combined, compared and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to these quantities.

Further, the manipulations performed are often referred to in terms, such as adding or comparing, which are commonly associated with mental operations performed by a human operator. No such capability of a human operator is necessary, or desirable in most cases, in any of the operations described herein which form part of the present invention; the operations are machine operations. Useful machines for performing the operation of the present invention include general purpose digital computers or similar devices.

The present invention also relates to apparatus for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove more convenient to construct more specialized apparatus to perform the required method steps. The required structure for a variety of these machines will appear from the description given.

### DESCRIPTION OF PREFERRED EMBODIMENT OF INVENTION

The exploration of comets with automatic probes has been a very interesting goal in view of the advances in planetology, bioastronomy and other sciences which are made possible by a better understanding of these objects. Basically a mission to a comet can consist of a simple flyby or in a true rendezvous, possibly resulting in an actual landing, and, as an ultimate goal, in the collection and retrieval of samples.

A number of comet flybys has been performed in the past, as the encounter with comet Giacobini-Zinner by the International Comet Explorer, that with Halley comet by the Giotto, Vega, Sagigake and Susei probes and, finally, the flyby of comet Grigg-Skjellerup by the Giotto Extended Mission. The drawback of missions of this type is the low duration of the encounter which usually occurs at very high relative velocity, which can be as high as 68.7 km/s as in the case of the Halley flyby by Giotto on Mar. 13, 1986. Also in the case of encounters with lower relative velocity, as that of comet Grigg-Skjellerup again by Giotto which occurred at 14 km/s, the time for which the spacecraft remains near the objective is very short.

It is worth to note that Giotto encountered the Halley comet 32 days after it passed at its perihelion, at a distance of only 610 km, a distance from the Sun of 0.89 UA and from the Earth of 0.96 UA.

Missions aimed to perform a rendezvous or, better, a landing on a comet are complicated and costly missions, expensive in terms of velocity increments ΔV of the spacecraft. If a comet-nucleus sample return is required, the complication and cost of the mission becomes so large that no such missions are planned for the future, after ESA's Rosetta was downgraded in 1992. Nevertheless this mission remains one of the cornerstones of the Horizon 2000 Plus ESA programme and very large scientific expectations are laid in it: the very name of the mission suggests that it is expected that it will yield the key for a deep knowledge of the solar system.

The typical way in designing a mission to a comet is to choose a comet which is in a stable Keplerian ellipse about the Sun which stays sufficiently far from any planetary body. This is the case, for example, with ESA's Rosetta mission. This approach is straight forward and minimizes complications that would develop if the comet were to be significantly gravitationally perturbed by another body during the rendezvous or mission. However, as already stated, the energy required by the spacecraft in order to rendezvous with a comet can be significant. Belbruno, E.; Genta, G., “Low Energy Comet Rendezvous using Resonance Transitions”, Proceedings on the First IAA Symposium on Realistic Near-Term Advanced Scientific Space Missions, International Academy of Astronautics, Torino, June 1996 describes the following way to reduce this energy for a special class of comets which are significantly perturbed by Jupiter and perform so called “hop dynamics.”

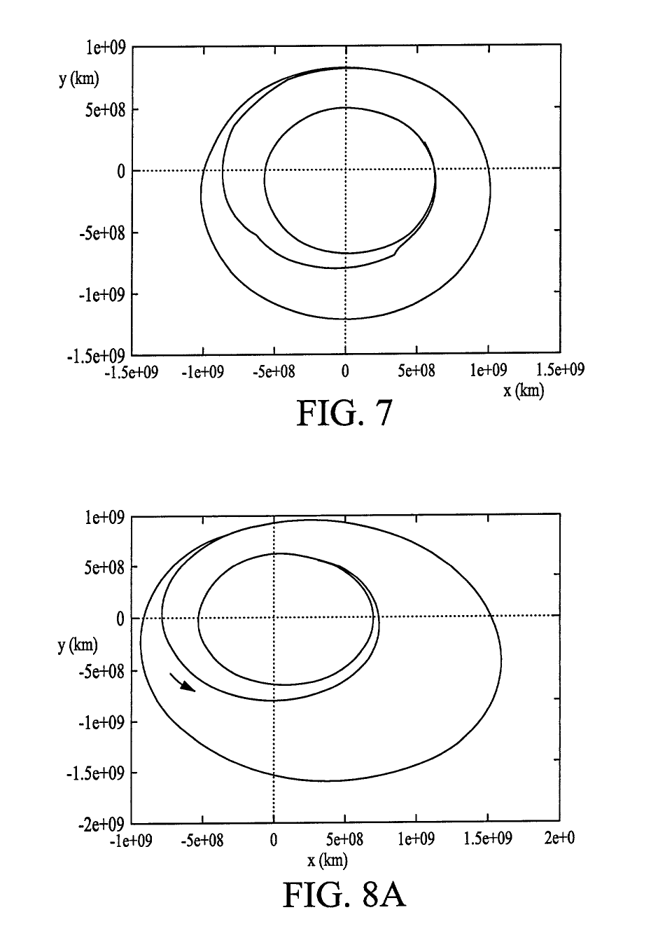

There is a region around Jupiter where a comet will move in a very sensitive way if it has the correct velocity. This region is called the “fuzzy boundary”. When a comet moves in the fuzzy boundary it is very weakly gravitationally bound to Jupiter. It is barely elliptic with respect to Jupiter, and in a relatively short period of time of the order of Jupiter's period, the comet will escape the planet and become hyperbolic: this temporary capture is called 'weak capture'. Prior to becoming weakly captured, the comet is on a standard Keplerian ellipse with respect to the Sun, and after exiting weak capture it is on a different ellipse. There is a class of known comets in which both these ellipses are in resonance with respect to Jupiter. That is, when they perform say m revolutions about the Sun, Jupiter will perform n, where m and n are integers and not equal. These are labelled ‘m:n ellipses’. For example, the comet Gehrels 3 is initially on a 2:3 ellipse, and after weak capture is on a 3:2 ellipse, as shown in FIG. 7. Comets which go from one resonance ellipse to another via weak capture are said to ‘hop’ from one ellipse to another, and the process is called hop dynamics.

While a comet is weakly captured by Jupiter, and therefore in the fuzzy boundary, it is in a transition region where it is nearly parabolic with respect to Jupiter. This means that a spacecraft which is weakly captured by Jupiter with the same orbital conditions as the comet, can rendezvous with the comet with little or no energy. Thus, rendezvous with the comet can be reduced to weak capture by Jupiter. This yields a substantial reduction in energy, i.e. ΔV, with respect to that needed for a rendezvous with a comet far from Jupiter. Here, by rendezvous, is meant that the spacecraft matches the comet's position and velocity. This reduction is demonstrated in Section 2, and for Gehrels 3 yields a reduction of 86% in the rendezvous dV as compared to the standard approach.

A difficulty in performing such a rendezvous is first having the means of detecting and predicting hopping comets. Assuming a comet could be found in the correct time frame, then an interesting mission could be designed to place a spacecraft on the comet while it was weakly captured by Jupiter. Such a spacecraft could serve as a long duration cometary station which could gather valuable data as the comet orbits about Jupiter and the Sun.

The hop is defined in Belbruno, E., “Fast Resonance Shifting as a Mechanism of Dynamic Instability Illustrated by Comets and CHE Trajectories”, Annals of the NY Academy of Sciences, V822, in Near Earth Objects, May 1997; and Belbruno, E., Marsden, B., “Resonance Hopping in Comets”, The Astronomical Journal, V 13, n.4, pp 1433-1444, April 1997, and was first discovered in 1988. Belbruno, E., “Examples of the Nonlinear Dynamics of Ballistic Capture and Escape in the Earth-Moon System, AIAA Paper 90-2896, Proceedings of the 1990 AIAA Conference in Astrodynamics, August 1990.

A low energy transfer to comets has been discovered which is done while a comet is performing a hop. The motion of a small body, p, of negligible mass mₒ is modeled by the restricted three, four, and twelve-body problems. In these problems, p moves in the Newtonian gravitational fields of two, three or eleven other bodies, respectively, which are moving in prescribed elliptical orbits about their centers of mass. In the case of the three and four-body problems, the main perturbing bodies are the earth, E, moon, M, and sun, S, of masses m,, respectively, i=1,2,3. The three-body problem that will be considered is, E,M,p. The four-body problem will be E,M,S,p.

In these systems, p can be viewed as any small body of negligible mass with respect to E,S,M. For example, an asteroid. The twelve-body problem considered models the solar system. The additional eight bodies of masses m₁, i=4,5, . . . , 11, are Mercury, Venus, Mars, Jupiter, Saturn, Neptune, Uranus, Pluto. In this system, p represents a comet. In a coordinate system centered at the sun the positions of the planets are prescribed by the planetary ephemeris DE403 and are given by the functions X₁,(t) ε [symbol] ³, where t is time, i=1,2, . . . , 11. Let x=x(t) ε [symbol] ³ denote the position of p. The differential equations which describe the motion of p are given by

$$\ddot{x} = {\sum }_{i = 1}^{n} {Gm}_{i} ( x - {x}_{i} ) {\vert x - {x}_{i} \vert}^{- 3} , \qquad ( 1 )$$

where d/dt, and where n=2,3,11 for the three, four and twelve body problems respectively. In the latter case of the full solar system modeling, the gravitational effect of Jupiter and the sun are dominant, and the other planets are negligible for the class of comets considered.

Weak capture of p occurs at one of the smaller bodies of the main perturbing planetary bodies. For example, in the E,M system, it occurs at M. Weak capture is a temporary capture of p at M where the motion of p satisfies two conditions:

a. H_{M} =λ², λ near 0,

b. p is near stability transition,

H_{M} is the Kepler energy with respect to M,

$${H}_{M} = \frac{1}{2} {\vert v \vert}^{2} - \frac{{Gm}_{2}}{\vert x \vert} ,$$

where x v are the position, velocity, respectively, of p with respect to M, and G is the universal gravitational constant. The condition of p being near stability transition, ST, means that it is near a region where escape from M occurs within one cycle of motion about M. Condition a specifies that p is near escape, but not to the degree. Condition b is a refinement of this. The condition of ST is now more precisely defined.

Fix a line V which extends from the center of M. Let p be the distance along P. Fix a velocity vector v which is based along P whose magnitude v=v(p) is adjusted such that the eccentricity e=eₒ is fixed, 0≦eₒ <1. At each point along e numerically integrate System (1) with v perpendicular to Q. Two things generally happen. Let Ξ be the unique plane through Q, perpendicular to v. When System (1) is numerically integrated, either p will make a complete cycle about M without first having moved about E, or p will move about E before returning to Ξ.

In the former case, we say that the motion of p is stable, and in the latter, unstable. Intuitively it is seen that for p˜0 the motion should be stable, and for p sufficiently large, unstable. This is observed on the computer, and, moreover, it is found by interation that a well defined value p=p* exists such that the motion is stable for p<p*, and unstable for p>p*.

This critical value of p* defines the ST region. In the case where the motion of E,M are defined where they perform mutually uniform circular motion about their common center of mass, p* depends on four parameters. When they perform mutually elliptic motion, then there are five parameters. The region of ST as defined here is referred to as the fuzzy boundary. It is remarked that when p starts its motion near ST, it is possible that H_{M}=+δ². If this happens we say that p is in quasi-weak capture. It is noted that being near ST implies that p has no central body. The region near ST where both weak and quasi-weak capture occur is defined to be a Mather region.

When p starts in weak or quasi-weak capture, it is found that it stays near this state for a short period of time, and then abruptly escapes where, H_{M}>0 and is no longer near ST. For example, see FIG. 7.

As it turns out, weak capture gives rise to interesting dynamics and applications. Because weak capture, WC, is a state which can be reached from trajectories starting outside of it, it is then a place where capture can occur with minimal energy. This property makes it suitable for the capture of spacecraft from the earth with substantially less energy than the classical methods.

An interesting dynamics is called the hop. Let p be in an m:n resonant elliptical orbit with respect to the earth, in resonance with respect to the moon, where m≠n. That is, the period of p equals n/m times the period of the moon, where n,m are positive integers. Then p hops from the m:n ellipse to an i:j resonance ellipse, i≠j, if it transitions through WC or QWC at the moon. This was first discovered in 1988. If a hop occurs by transitioning from QWC, we refer to it as a quasi-hop. Although the above definitions have been made with respect to the moon, they carry over to the smaller of any two primaries. For example, Jupiter where the larger primary is the Sun. The hop was found to be associated with a class of short period comets in 1995.

It is remarked that the resonances referred to in this paper are not exact and are near resonances. That is, if _=_(t)=(x(t), _(t)) is a resonant orbit of with resonance period T_{R}=(n/m)Tₗ, T_{L}=one lunar period, then we require that _(T_{R}) lie in a neighborhood N of _(0).

A set of ten short period comets are shown to be performing the hop in a recent study completed in 1996. The first comet demonstrated to be performing a fast resonance shift was 39P/Oterma. Originally discovered in 1943 by Oterma herself, it was noticed in 1943 that after its first encounter with Jupiter in 1937 it was in a near 3:2 resonance with Jupiter, while prior to 1937 it was in a 2:3 resonance. Again in 1961, 39P/Oterma reencountered Jupiter, and after this encounter it shifted back to a 2:3 resonance which is discussed by Marsden. An analysis of these resonance transitions in 1995 showed that hops were occurring.

Some other selected comets have been shown to be performing hops or quasi-hops are 82P/Gehrels 3, 14P/Wolf, D/1770 LI(Lexell), 74P/Smirnova-Chemykh. The duration of the hops vary from a few months to 10 years. This is vastly faster than the classical method of shifting resonances, Arnold diffusion, where the duration of such shifts is often on the scale of millions or even billions of years.

Many of the comets are actually performing quasi-hops which tend to be associated with higher order resonances. For example, the comet 74P/Smimova-Chernykh is in this category, where a shift 6:13→7:5 occurs. The results indicate that the more stable shifts are the hops where the resonances 2:3, 3:2 generally appear. For example, 39P/Oterma, 82P/Gehrels 3 are in this category.

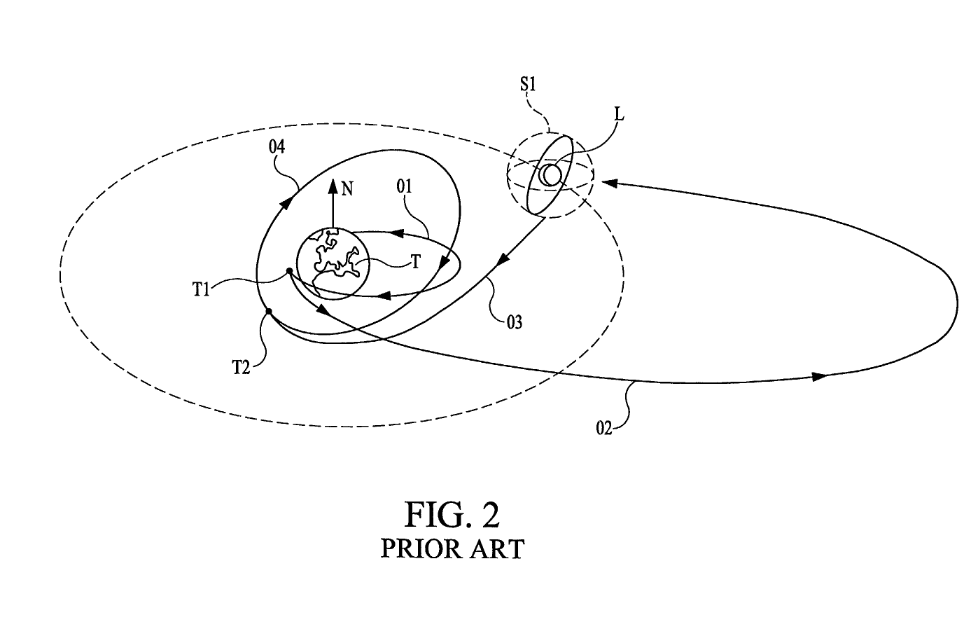

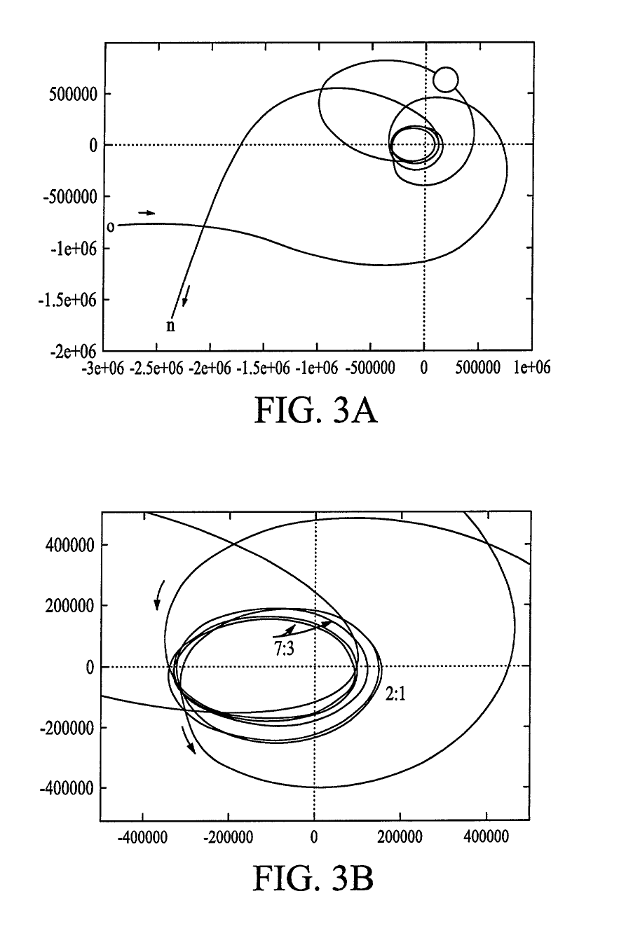

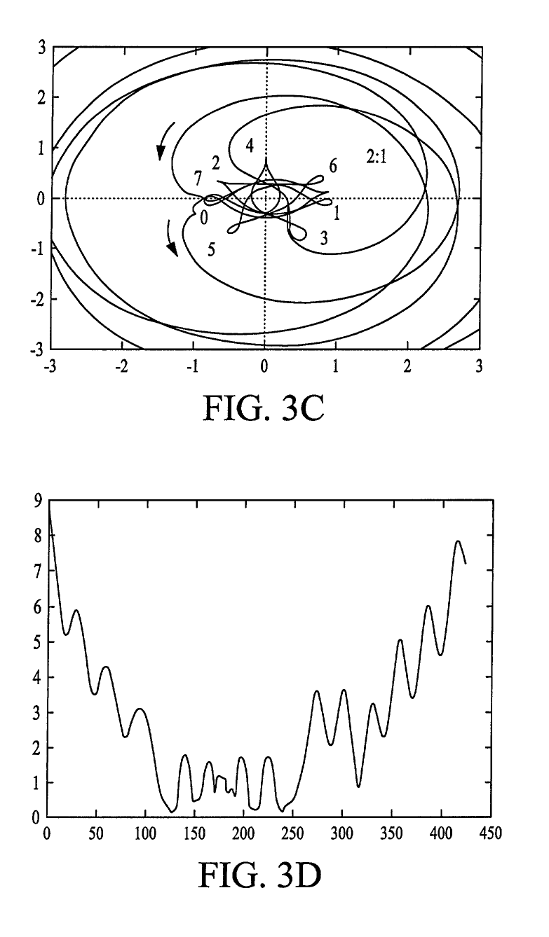

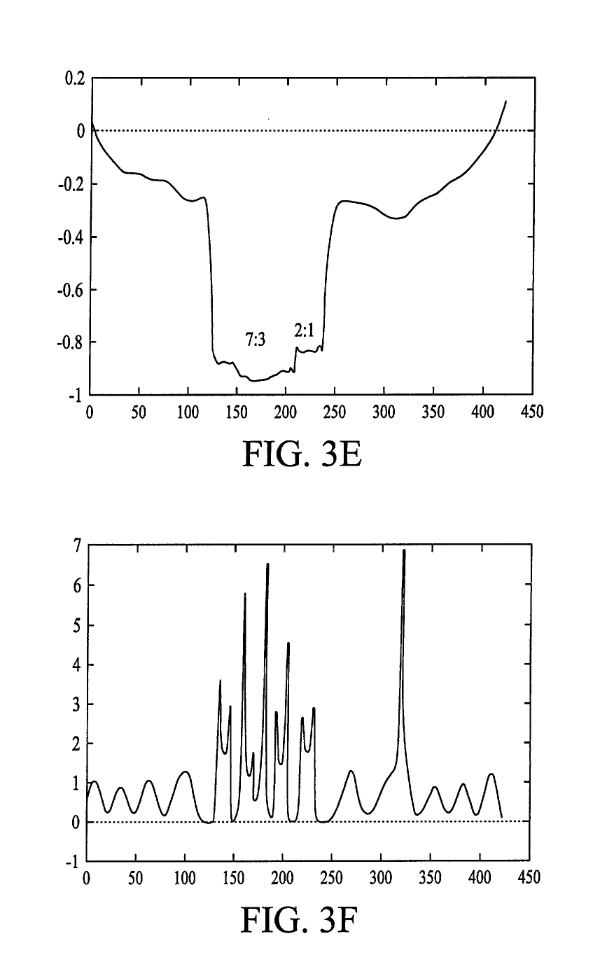

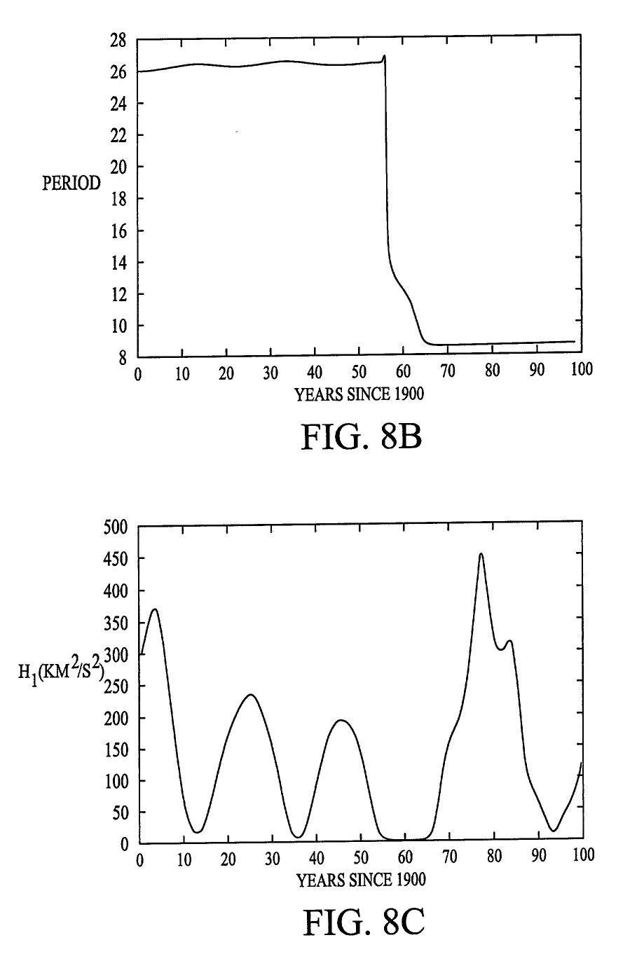

FIGS. 8A-8C show typical behavior during a hop. These figures are for the comet 74P/Smirnova-Chernykh which performed a quasi-hop starting on Jun. 1, 1955 and lasting until Apr. 13, 1956. FIG. 3A shows the 6:13 ellipse outside of Jupiter's orbit which has a nonlinear transition to the smaller 7:5 ellipse. It is integrated from 1900-2000. The variation of the energy with respect to the sun, H_{S}, has the characteristic level values for the different resonances with an abrupt jump between them. The plot FIG. 2B shows the period with respect to the sun which has the same behavior as H_{S}. FIG. 2C shows how the energy with respect to Jupiter, H_{J}, moves very near to zero typical for QWC during the quasi-hop.

The hop seems to be a robust process. This implies that it is not a dynamics which occurs with a zero probability, but rather is not too difficult to achieve. Mathematically, it seems to occupy a set of positive measure in the phase space.

Two results are mentioned. One relates to the comet 14P/Wolf, and the other to D/1770 LI(Lexell). 14P/Wolf is performing a surprising double resonance. That is, it is oscillating between 3:2 and 4:3. This implies that perhaps other interesting types of resonance oscillations may be possible. D/1770 L1(Lexell) shows that hopping comets can be earth crossers. In 1767 this comet did a quasi-hop from a 4:3 to a 2:1 and passed within 2.3 million km from the earth in 1770. Moreover, in 1779 it did a close flyby of Jupiter and possibly gained enough energy to be on an ellipse of an apoapsis of 92 A.U. which is within the Kuiper belt distance. Therefore, this comet makes a link between comets moving out within the Kuiper belt and those which can become earth crossers via the hop.

These results are obtained by numerical integration of System (1) for the solar system modeling with n=11. They are started from observational data, and monitored for roundoff error by checking the positions of the comets with other data and by insuring that forward and backward integrations agree. Because of the sensitivities of the hop dynamics, continuous numerical integrations over two hundred years are not done, unless by shadowing methods. A numerical integrator of order 10 is used together with the planetary ephemeris DE403.

The hop persists when S,J are modeled and in the idealized elliptic restricted three-body problem,E³, between Jupiter,J, and S, p, where J and S move on uniform ellipses about their common center of mass. In fact, it also persists in the case J,S are moving uniformly on circles, which is called the circular restricted three-body problem,C³. For nomenclature, only S,J are modeled using DE403, we refer to this as the pseudo-elliptic restricted three-body problem,PE³. As far as numerical integration and modeling is concerned for the time spans considered here, the difference between E³ and PE³ is negligible.

The speed of the hop has been seen to be approximately nine orders of magnitude faster than Arnold diffusion. Observationally, this gives rise to the abrupt changes in the elliptical orbits of certain comets. The hop and CHE's are mechanisms which provide examples of how change can occur rapidly in the solar system from elliptic orbits.

When the hop occurs two things of note are taking place. First, the particle p is able to quickly move from one resonance orbit to another which can be quite far apart. For example, the comet 74P/Smirnova-Chernykh which goes from a 6:13→7:5 shown in FIG. 2A. The nonlinear transition through the hop moves through a large region of the phase space, and only over approximately one year. Second, the particle is going from one resonance to another.

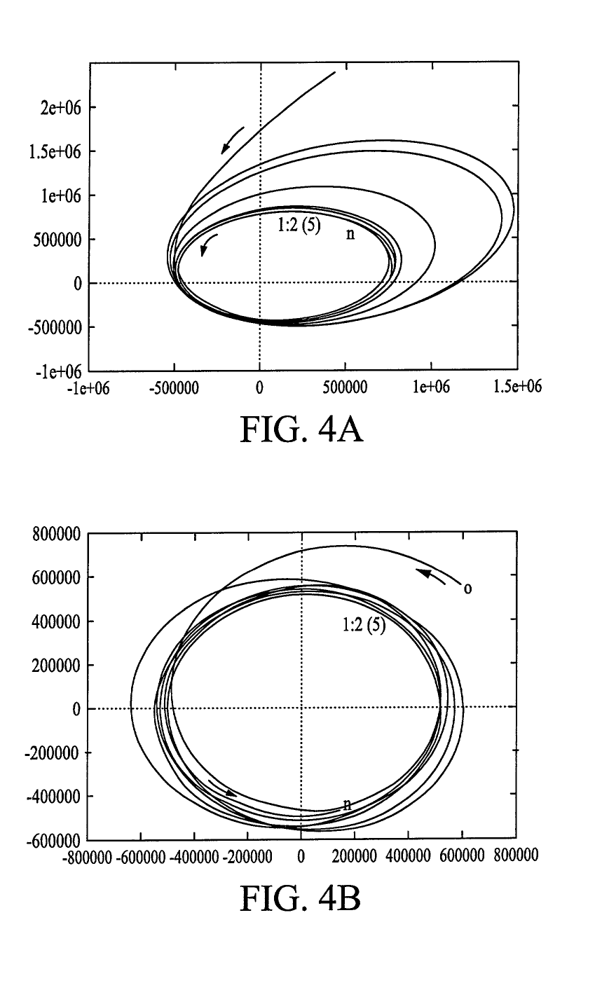

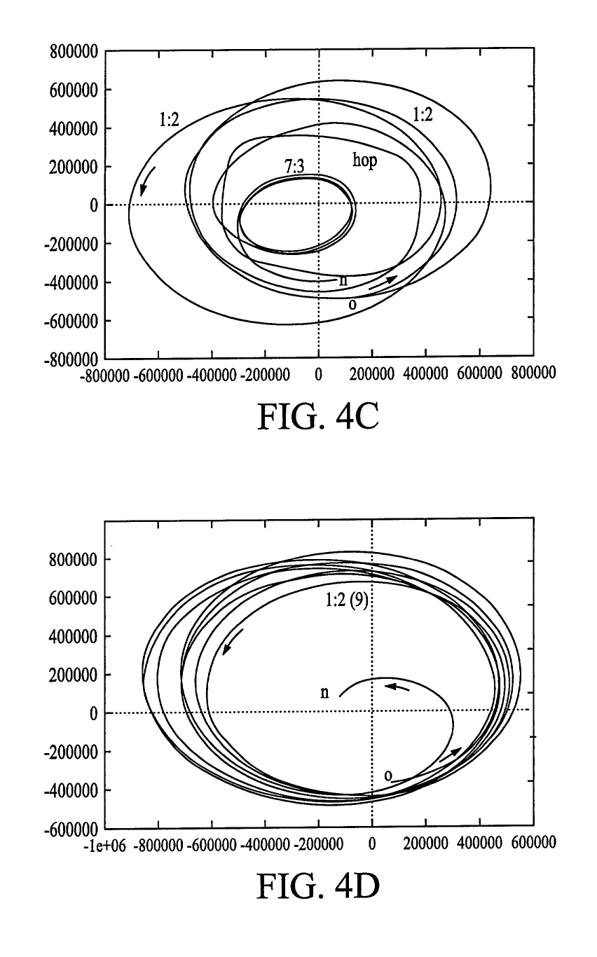

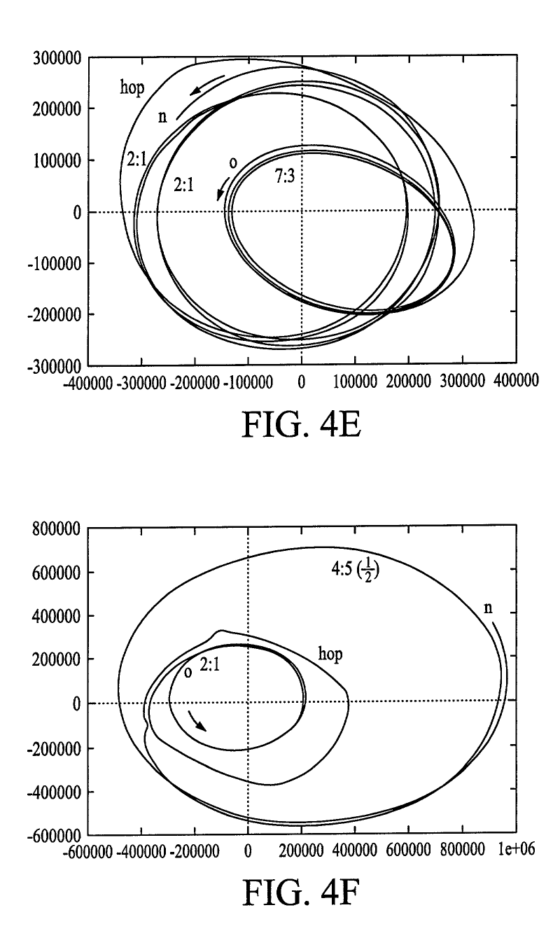

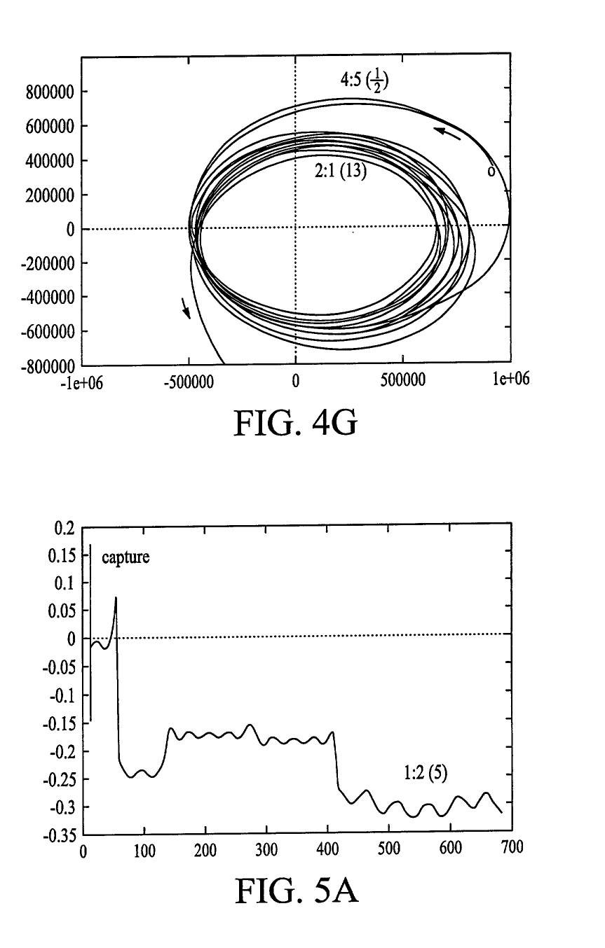

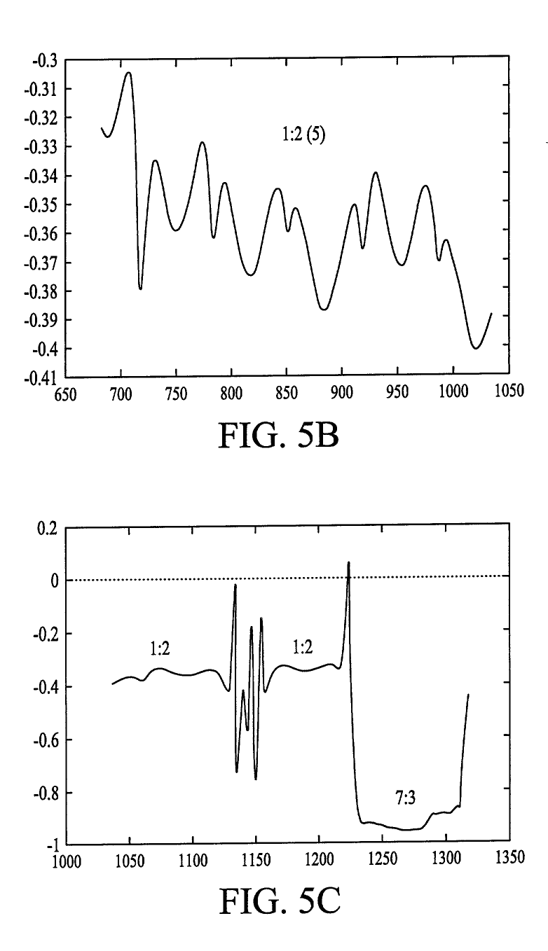

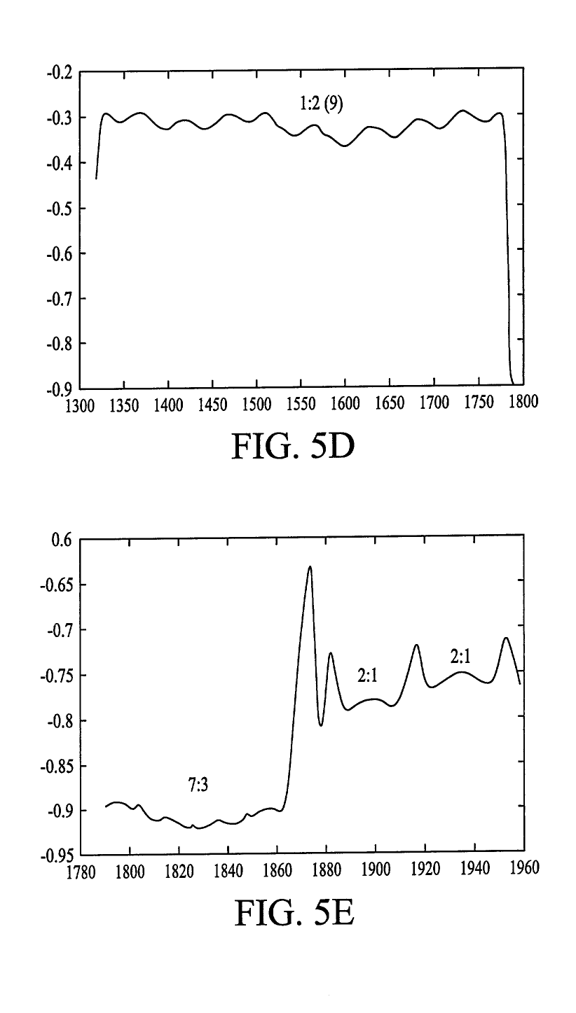

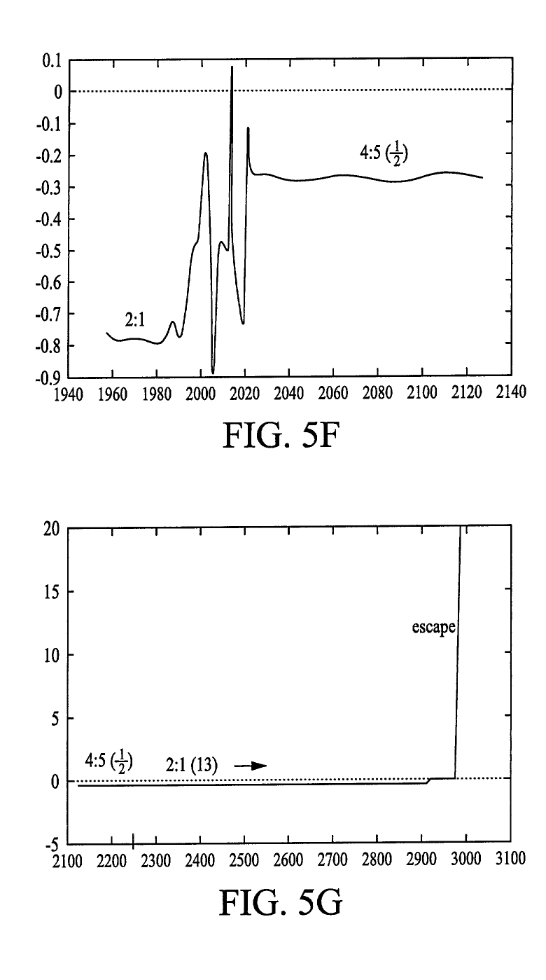

The former case can be understood by first showing that the two resonance orbits that the particle is transitioning between are unstable. This is done by computing the variational matrix, M, associated with each orbit, and show it has purely real eigenvalues indicating unstable hyperbolic behavior. For example, if the orbit is given by _=_(_,t) ε [symbol] 6, where _(_{—},0)=_, then

$${M = \frac{\partial ϕ}{\partial {ϕ}_{o}} \vert}_{t = Tr} ,$$

where TR is the period of _. There are six eigenvalues, λi, i=1, 2, . . . , 6 occurring in complex conjugate pairs. Two of these are real, one being the inverse of the other. This is carried out, for example, for the case shown in FIG. 4F. Associated to these two eigenvalues are a stable and unstable manifold each of two dimensions. Locally, they are tangent to the space spanned by the two eigenvectors associated to the unstable eigenvalues. The hop indicates that these manifolds intersect.

For example, referring to FIG. 2A, the unstable manifold of the 6:13 should intersect the stable manifold of the 7:5. Recent numerical investigations show this is indeed the case. It is necessary to numerically extend the stable and unstable manifolds until their intersection is observed.

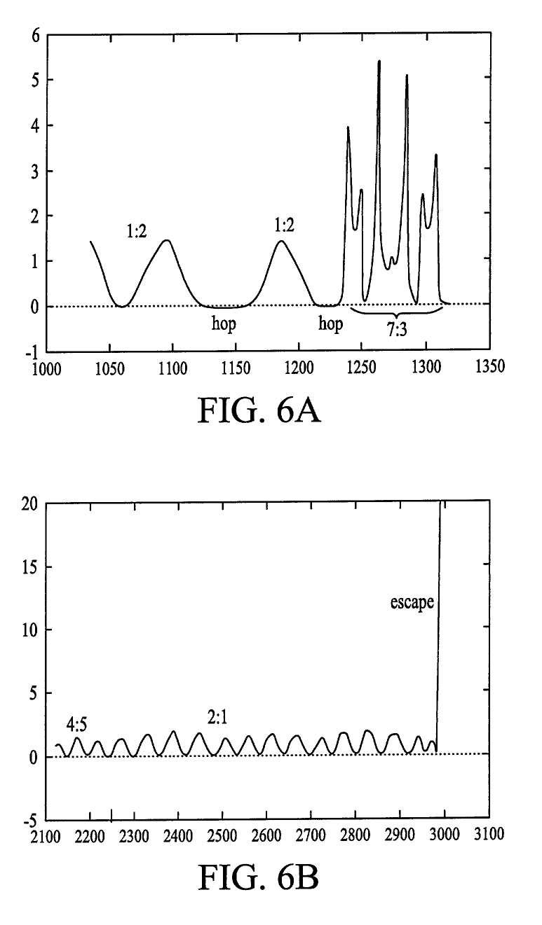

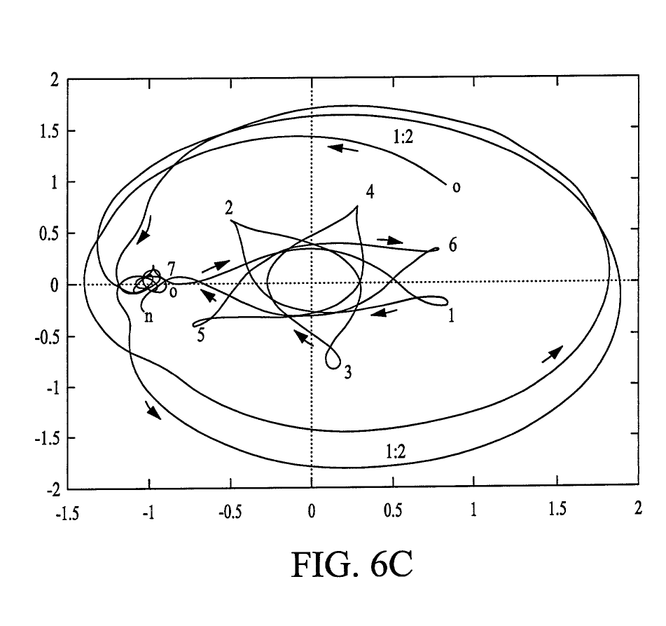

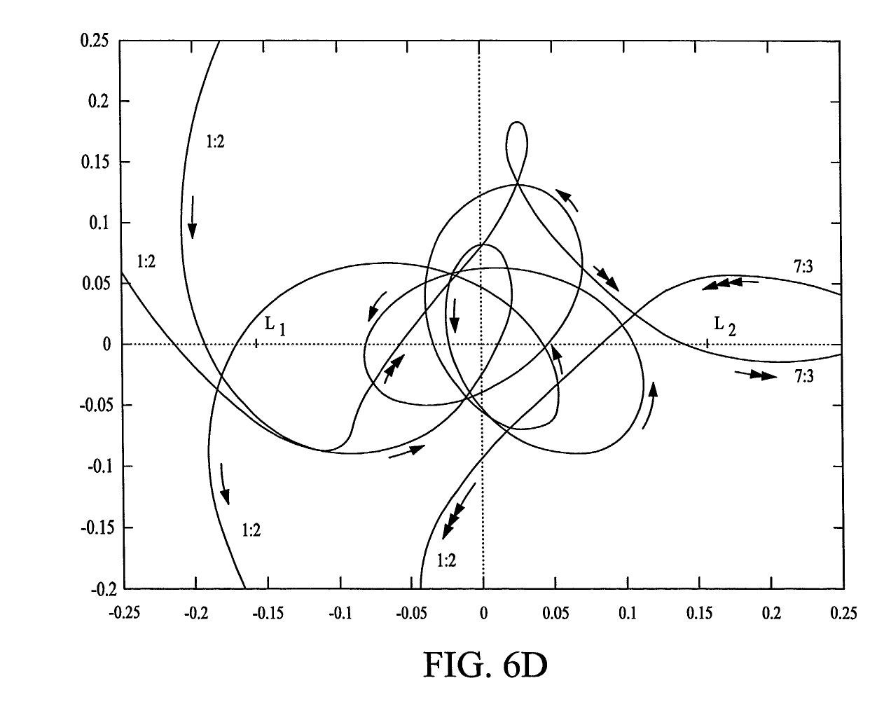

The intersection of these stable and unstable manifolds implies that they intersect infinitely often in a very complex structure called a hyperbolic tangle. The motion near such a tangle should be very complicated. This manifests itself in the fact that the hop dynamics should be very nonlinear. For example, see FIG. 6D. There are times where the hop may not appear to be too nonlinear. This is because it is occurring in a short period of time, and is fairly direct. However, a closer examination shows a complicated behavior.

It is noted that the hops occur near the smaller of the two primaries in all the cases considered. This is evident in the fixed coordinate plots included here. Moreover, the hops seem to exit and enter near the Lagrange points L₁, L₂. More precisely, in all cases considered, the hops occur near the apoapsis or perapsis locations of all the resonance orbits with respect to the larger primary, which lie near these Lagrange points. It turns out that near these Largange points in phase space are retrograde unstable periodic orbits called Lyapunov orbits, which also have two-dimensional stable and unstable manifolds.

Numerical investigations indicate the possibility that these manifolds may intersect, and form a hyperbolic tangle that surrounds the smaller of the two primaries, say M or J. The physical locations of L₁, L₂ with respect to M are shown in FIG. 6D. This tangle is conjectured to be the ST region, or fb. The tangle formed from the resonant period orbits lies within this tangle.

The second property of note is the fact that the particle moves near resonance states after escaping from ST. A probable reason why this happens is related to the work of Mather in a lower dimensional setting corresponding to two degrees of freedom. Translated to the C² problem on a two-dimensional energy surface Σ his results prove that in the absence of two-dimensional KAM tori, the phase space consists of unstable resonant orbits, with associated stable and unstable manifolds which in general intersect, therefore forming hyperbolic tangles. These unstable resonant orbits are referred to as Aubry-Mather sets, or Birkoff periodic orbits. Translating this to a higher dimensional setting, such as the E³, or PE³ problems would help explain the resonance shifting.

I have determined that the hop is a mechanism where a small mass point can rapidly shift from one resonance to another about a primary mass particle relative to the near circular motion of a secondary mass particle in the Newtonian circular threedimensional restricted three-body problem. More precisely, an assumed situation is where a mass particle of relatively small mass, a so-called secondary mass, is moving in a near circular orbit about a much larger primary mass particle.

An example of this would be the moon, M, as a secondary moving about the earth, E, as a primary. For this situation we try to determine the motion of a mass particle m whose mass is negligible with respect to E and M, so that they gravitationally effect m, but not conversely. Let's assume then, that m is a spacecraft. The motion of m in three dimensions is not in general known. As discussed above, an interesting discovered motion m can have is called the hop, first noticed in 1988. Belbruno, E., “Examples of the Nonlinear Dynamics of Ballistic Capture and Escape in the Earth-Moon System, AIAA Paper 90-2896, Proceedings of the 1990 AIAA Conference in Astrodynamics, August 1990.

Let's assume m is moving in resonance with respect to M. This means that we assume m is moving in a near elliptic orbit about E with a period of motion which is a fractional multiple of M's. Thus, if we label the period of M about E to be P(M), which is about 27 days, then the period of m about E, P(m), is given by

I P(m)=J P(M),

I,J=1,2,3 . . . . The motion of m in this case is said to be in a I:J resonance. This means that in the time it takes M to go around E, J times, m goes around E, I times. Another way of thinking of this is that m and M are in synchronous motion. For example, a 2:1 resonant motion of m means that in the time it takes m to go around B twice, M goes around once. The period of m is then one half of the period of M, or about 14 days. Now, as m moves about E and does not come too close to M, it will stay on it's I:J resonant orbit, or I:J orbit for short. As described in Belbruno, E., Marsden, B., “Resonance Hopping in Comets”, The Astronomical Journal, V 13, n.4, pp 1433-1444, April 1997, the I:J orbit will change only in a negligible amount if its position and velocity are such that m is outside of the fuzzy boundary, or weak stability boundary (WSB), of M. This means that m's orbit can change appreciably only if m moves close enough and slow enough with respect to M.

If the position and velocity coordinates are just right; that is, they lie on a special five-dimensional set characterizing the WSB, then the motion of m is very sensitive. Ifs two-body Kepler energy with respect to M, KEP(M), is very near zero, and slightly negative. In this case m is said to be weakly captured by M. In general, when m is weakly captured by M it orbits about M chaotically for a short period of time, say a few hours, and then is ejected from M, and escapes. This means that KEP(M) goes from slightly negative to positive. The chaotic motion is due to the geometric structure of the WSB which is conjectured to be a so called hyperbolic tangle consisting of infinitely many intersections of invariant surfaces called hyperbolic manifolds, the boundary of which is not well defined.

The hop can now be defined as a transition from one resonant motion of m about E, I:J, w.r.t. M to another, K:L, by passing through weak capture. Symbolically,

I:J→K:L (2)

K,L=1,2,3 . . .

This process was first discovered in 1988 where 2:1→2:5. Dynamically, the hop is very significant since it occurs so quickly—on the order of a month or so. This speed is much faster than the accepted speed for transitioning resonances via a standard process called Arnold Diffusion which says that instead of a month, time scales on the order of tens of millions of years should be expected. The connection of the hop was made with the motion of real comets reported in Belbruno, E., Marsden, B., “Resonance Hopping in Comets”, The Astronomical Journal, V 13, n.4, pp 1433-1444, April 1997. In this case, the particle m is a comet, the primary mass particle is the Sun, and the secondary mass particle is Jupiter.

Because, I have determined, the hop occurs quickly as opposed to previous opinions or views that the hop occurs too slowly to be of any practical use, and because the hop provides ways to move between capture and escape, it can be used in a number of applications.

Application 1: Energy Increase for Earth Ejection

A variation of the hop is described which has a number of possible applications. Mass m starts its 3 0 motion on an 2:1 orbit about E of eccentricity .4 and semi-major axis of 240,000 km. The apoapsis of this orbit is taken as the initial state. The period of the orbit, 0, is 27 days and 7 hours which is one lunar period. 0 lies within the E-M distance and m performs two cycles about E, returning to its starting position to high precision. This position is at a distance of 352,499 km from E, and m has a velocity such that it is in the WSB of the moon, and therefore weakly captured—KEP(M)<0.

Because of the complexity of the dynamics in the WSB, m is pulled away from the apoapsis and for approximately 34 days it performs a complex out-of-plane oscillation about M resulting in five lunar flybys. It then is ejected from M and transitions into a much larger ellipse which is a 5:2 orbit about E with a semi-major axis of 700,000 km and eccentricity .3. During this simulation or operation, the gravitational effect of the Sun is not modeled or considered.

When the Sun is modeled, m does not transition into a resonant ellipse. Instead m is ejected from the E-M system with a hyperbolic excess velocity, Vinf, of 0.384 kms, or a C3=Vinf×Vinf=0.147 km2/s2. It settles into an orbit E1 about the Sun, S, with a semi-major axis of 1.049 AU, AU =149,600,000 km and eccentricity of .038. The total time of flight from the beginning of the 2:1 orbit to reaching the apoapsis of the ellipse El about the Sun, which is reached at the end of the ejection process, takes approximately 250 days. The inclination w.r.t. the ecliptic is 0.15 degrees.

The modeling of the Sun yields a more realistic situation. These dynamics are preserved when the remainder of the planets are modeled using the planetary ephemeris DE403 together with the precision numerical integrator that was used in the related provisional and PCT applications listed in the Related Applications Section above. Thus, in summary the dynamic path of m is represented as,

2:1→WSB transition→Ejection→E1 (2)

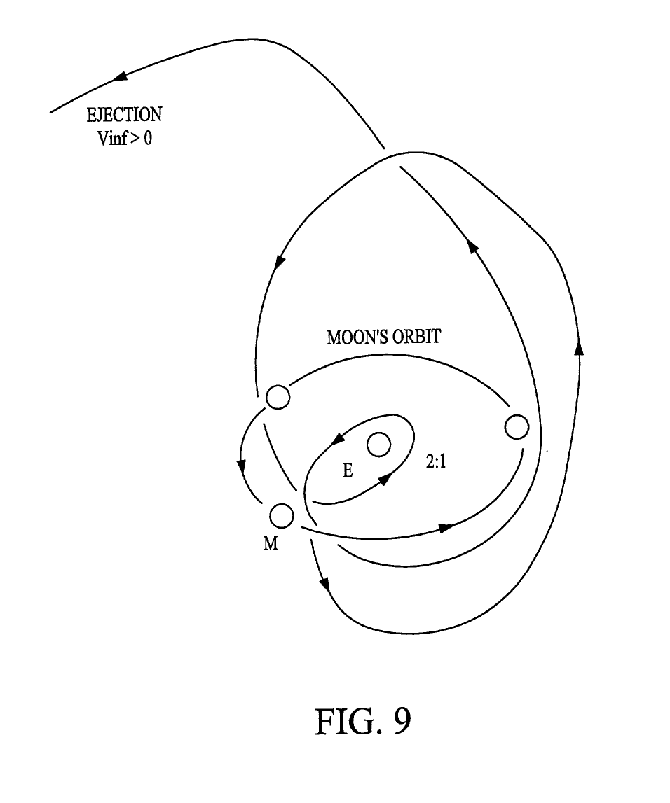

The WSB transition is similar to the hop. It is a complex out-of-plane oscillation, resulting in three lunar flybys. A schematic of this is shown in FIG. 9.

In order to reach the starting point, a, at the apoapsis of the 2:1 orbit, a WSB transfer can be used from the earth, say at 500 km altitude suitable for the Arianne V launch vehicle at the periapsis of a geostationary transfer orbit. A transfer of this type is documented in the above patent applications listed in the Related Applications Section. It leaves the earth at the 500 km altitude periapsis with a C3 of −1.33 km2/s2, and 94 days later it arrives at a. The transfer has been targeted to arrive at a to match the initial velocity of the 2:1 orbit. This is symbolically denoted as,

Earth injection→WSB transfer→2:1 (3)

In Summary:

Relations (1), (2) taken together provide a way to leave earth from the periapsis of a geostationary transfer orbit to ejection from the earth-moon system. The total time of flight from the initial earth injection to the apoapsis of E1 is 344 days. No maneuvers are required, except the initial C3 of −1.33 km²/s² which can be provided by the launch vehicle which is assumed for sake of argument to be an Arianne V. The final C3 is 0.147. Thus, an increase of C3 by 1.487 is obtained ballistically.

The increase of C3 by 1.487 units is obtained with no maneuvers, and therefore, propellant is saved either by the spacecraft m or the launch vehicle. If the launch vehicle is used, then more mass can be sent out of the earth moon system for the same cost, or the spacecraft can be made less massive. If the savings are enough, a smaller class of launch vehicle can be used. Trades of this type depend on the spacecraft design, type of launch vehicle and other constraints.

Additional performance can be obtained from the ellipse E1 by doing a small maneuver to leave the apoapsis of E1 and performing a 1:1 earth transfer. In this way the spacecraft arrives at earth in six months where a flyby together with another small maneuver at earth periapsis can increase the C3 significantly. It was found that a maneuver of 42 ms done at the apoapsis of E1 together with a flyby of the earth six months later increased the C3 from 0.147 to 4.88. This gives a total C3 increase of 6.21, which is significant and can save substantial propellant.

It turns out that increasing the C3 in this way for the example here was enough to raise the apoapsis distance from the Sun to Mars distance of 1.5 AU. Thus, a Mar's transfer can be done with a C3 of only −1.33. The main tradeoff is the time of flight which is approximately two years to reach Mars. It is remarked that Penzo, P., “Lunar and Planetary Missions Launched from Geosynchronous Transfer Orbit”, AAS 97-172, Advances in the Astronautical Sciences, V95, Spaceflight Mechanics, 1997, performs multiple lunar flybys as well; however, not starting from a resonance orbit. His method is more constrained due to the type of lunar flybys where more maneuvers are required. A similar comment holds for the work in Kawaguchi, J.; Yamakowa, H.; Uesugi, T.; Matsuo, H.; On Making Use of Lunar and Solar gravity Assists in Lunar-A, Planot-B Missions, Acta. Astr., V35, pp 633-642, 1995.

The lunar flybys used in Penzo and Kawaguchi et al. are not strictly of the WSB type. The enhanced nonlinearity of the WSB region gives more flexibility in the timing on when to be ejected than the other methods. Also, my method requires no significant maneuvers.

Thus far, the use of a WSB transfer (optional), together with a resonant orbit and lunar flybys in the lunar WSB to increase C3 has been described. This can be augmented by using a 1: 1 earth flyby. This is valid not just in the example given here, but, I have discovered, significantly in the more general case of escaping the earth-moon system by entering the lunar WSB and performing a set of lunar flybys while in the boundary. Although a resonant orbit in the example was used to enter the lunar WSB, such an orbit is not necessary and the boundary can be entered by any type of transfer. The essential point of this invention is the use of the WSB while the spacecraft is performing lunar flybys to increase the C3. The above example is used for argument sake only.

The initial increase of the C3 to 0.147 is useful for reaching earth crossing asteroids. The value of 0.147 is just for the example given, and a wide range of values are possible.

Application 2: Capture in the Earth-Moon System

Another application presented here is the reverse process. That is, starting from outside the earth-moon system in a hyperbolic state, then approaching the WSB of the moon in the desired direction, the C3 of m can be decreased by oscillating in the WSB resulting in capture, about the earth. The resulting capture orbit could be resonant, although this is not necessary. This technique reduces the required propellant for capture into earth orbit, and could be done in a consecutive fashion to gradually reduce the energy w.r.t. the earth. It may be useful for asteroid return missions, or as a way to facilitate capture of an asteroid itself.

Therefore, by using the lunar WSB to execute lunar flybys, and by possibly entering the boundary using a resonant orbit if desired, a substantial savings of propellant can be obtained which can be used to increase the mass of the spacecraft or decrease the size of the launch vehicle class.

Application 3: Transferring to Hopping Comets, Asteroids, Spacecraft

This application relates in general to methods for space travel, and, in particular, to methods for an object, such as a satellite, spacecraft, and the like, to perform a low energy rendezvous, or transfer with a comet or asteroid, or another small object, while the object is performing a resonance transition, or equivalently a hop, at the WSB of a larger planetary body such as Jupiter, Saturn, Earth, etc. Approximately 86% fuel can be saved by this method.

All one needs is for a small object to be moving about a primary body, and being in resonance with a satellite, or secondary body, of the primary body. The small object can be any object which has a negligible gravitational effect on the primary or the secondary. The small object could then hop at the WSB of the secondary.

Thus, for example, (Primary, Secondary, small object) could be, respectively, (Sun, Jupiter, Comet), (Sun, Saturn, Asteroid), (Earth, Moon, Asteroid), (Earth, Moon, Spacecraft), (Sun, Mars, Asteroid), (Saturn, Titan, Spacecraft), (Saturn, Phoebe, Asteroid), etc. There are unlimited possibilities. The application described below will apply to all these various situations and is stated in a general fashion, without regard to any specific situation. One situation is described in Belbruno, E.; Genta, G., “Low Energy Comet Rendezvous using Resonance Transitions”, Proceedings on the First IAA Symposium on Realistic Near-Term Advanced Scientific Space Missions, International Academy of Astronautics, Torino, June 1996, for the first case of (Sun, Jupiter, Comet). This reference, however, does not deal with, ir relate to, a more general framework with, for example, the situations of (Earth, Moon, Asteroid), (Earth, Moon, Spacecraft).

A substantial amount of energy can be saved when transferring and making a rendezvous by a spacecraft, SC, with an object that is performing a hop at a secondary while it is in the WSB.

The concept of saving energy is as follows: A small object SO, is at the WSB of a secondary body, 10 SB, and is performing a hop from N:M to L:K. Consider a time epoch t while in this process. Assume SO is a distance r from SB. At this time t, the SO's standard Kepler energy with respect to SB is slightly negative and very close to zero, since it is in the WSB, and very weakly captured. If a SC transfers to SB from some distant point p on a standard Hohmann transfer, and makes a rendezvous with SO at time t with it so its relative velocity to SO is zero at time t, then it will also be in the WSB of SB. It will also have the same energy with respect to SB that SO has at time t.

Because SC is therefore weakly captured at SB at the WSB, it has used minimal energy with respect to SB for the capture. It is easily calculated knowing the distance r from SB, and the velocity magnitude v with respect to SB, and is calculated as:

E1=½vˆ 2−GM/r,

where G is the universal gravitational constant, and M is the mass of SB.

The velocity v that SC required to have to rendezvous with SO in the WSB of SB is minimized by virtue of the weak capture with SB. One can state this as saying that SB minimally slowed SC down to rendezvous with SO. Thus, the gravity of SB minimally slowed SC down for SO rendezvous. This is called, in general, gravity loss, and this process of gravity loss is magnified due to being in the WSB of SB.

The energy SC required for rendezvous with SO can be equivalently measured in the velocity that SC required in order to match the velocity v of SO with respect to SB. Assuming at time t at rendezvous with SO, the velocity of SC with respect to SB is v1, then the so called, delta-V,

DV1=|v1-v|

gives a measure of the energy for rendezvous. This is compared to the problem of rendezvous of SC with SO, when SO is not near SB is negligibly effected by the gravitational perturbation of SB, at time t. We again assume SC transfers to rendezvous with SO from a distant starting point p, as before. We assume it moves to rendezvous on a Hohmann transfer. The arrival velocity at SO, relative to SO, is a value v2.Again, the delta-V is calculated,

DV2=|v2-v|.

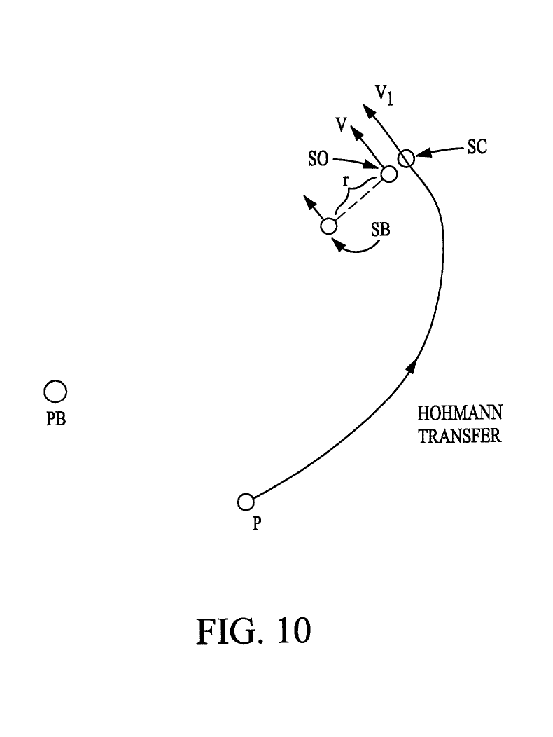

In many cases, the value of DV1 is much smaller than DV2, thus giving a large fuel savings. See FIG. 10 attached.

A specific example is described in Belbruno, E., Genta, G., “Low Energy Comet Rendezvous using Resonance Transitions”, Proceedings on the First IAA Symposium on Realistic Near-Term Advanced Scientific Space Missions, International Academy of Astronautics, Torino, June 1996., however, the data is given here relative to the much more general framework just described.

Application 4: Inclination Changing

This application describes a way to change the inclination of resonant orbits about the earth. When a hop occurs the inclination of the orbit also changes from one resonance orbit to another. This inclination change can be large. and is easily obtained. For example, where a hop occurs from a 2:1 to a 5:2, I have determined the inclination also changes from 29.7 degrees to 21.5 degrees w.r.t. the earth. By adjusting the way m is ejected from the WSB, different inclination changes can be obtained. This provides a mechanism to change inclination using the moon which under certain circumstances may be more advantageous than other methods.

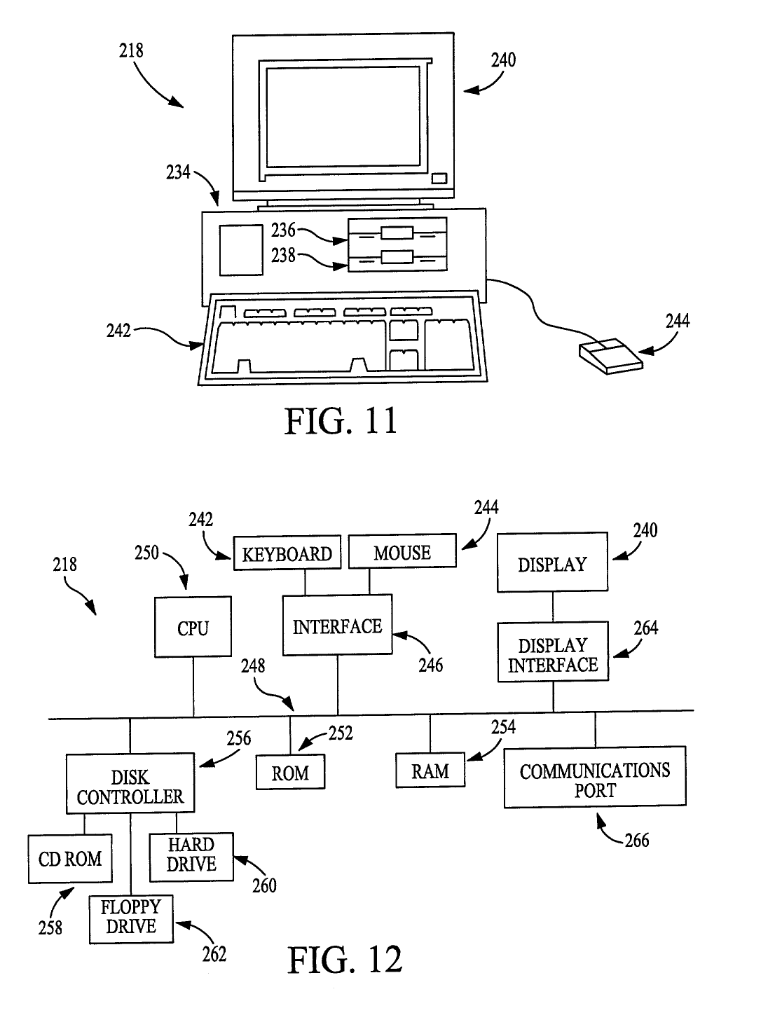

FIG. 11 is an illustration of main central processing unit 218 for implementing the computer processing in accordance with one embodiment of the above described methods of the present invention. In FIG. 11, computer system 218 includes central processing unit 234 having disk drives 236 and 238. Disk drive indications 236 and 238 are merely symbolic of the number of disk drives which might be accommodated in this computer system. Typically, these would include a floppy disk drive such as 236, a hard disk drive (not shown either internally or externally) and a CD ROM indicated by slot 238. The number and type of drives varies, typically with different computer configurations. The computer includes display 240 upon which information is displayed. A keyboard 242 and a mouse 244 are typically also available as input devices via a standard interface.

FIG. 12 is a block diagram of the internal hardware of the computer 218 illustrated in FIG. 11. As illustrated in FIG. 12, data bus 248 serves as the main information highway interconnecting the other components of the computer system. Central processing units (CPU) 250 is the central processing unit of the system performing calculations and logic operations required to execute a program. Read-only memory 252 and random access memory 254 constitute the main memory of the computer, and may be used to store the simulation data.

Disk controller 256 interfaces one or more disk drives to the system bus 248. These disk drives may be floppy disk drives such as 262, internal or external hard drives such as 260, or CD ROM or DVD (digital video disks) drives such as 258. A display interface 264 interfaces with display 240 and permits information from the bus 248 to be displayed on the display 240. Communications with the external devices can occur on communications port 266.

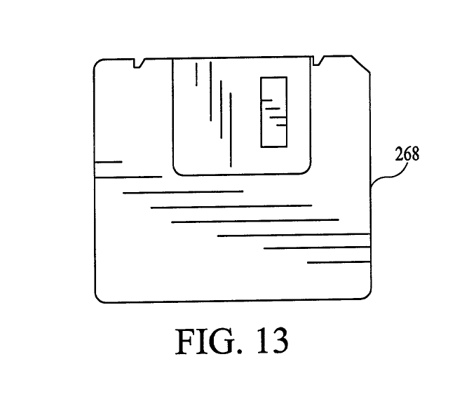

FIG. 13 is an illustration of an exemplary memory medium which can be used with disk drives such as 262 in FIG. 12 or 236 in FIG. 11. Typically, memory media such as a floppy disk, or a CD ROM, or a digital video disk will contain, inter alia, the program information for controlling the computer to enable the computer to perform the testing and development functions in accordance with the computer system described herein.

Although the processing system is illustrated having a single processor, a single hard disk drive and a single local memory, the processing system may suitably be equipped with any multitude or combination of processors or storage devices. The processing system may, in point of fact, be replaced by, or combined with, any suitable processing system operative in accordance with the principles of the present invention, including sophisticated calculators, and hand-held, laptop/notebook, mini, mainframe and super computers, as well as processing system network combinations of the same.

Conventional processing system architecture is more fully discussed in Computer Organization and Architecture, by William Stallings, MacMillam Publishing Co. (3rd ed. 1993); conventional processing system network design is more fully discussed in Data Network Design, by Darren L. Spohn, McGraw-Hill, Inc. (1993), and conventional data communications is more fully discussed in Data Communications Principles, by R. D. Gitlin, J. F. Hayes and S. B. Weinstain, Plenum Press (1992) and in The Irwin Handbook of Telecommunications, by James Harry Green, Irwin Professional Publishing (2nd ed. 1992). Each of the foregoing publications is incorporated herein by reference.

In alternate preferred embodiments, the above-identified processor, and in particular microprocessing circuit, may be replaced by or combined with any other suitable processing circuits, including programmable logic devices, such as PALs (programmable array logic) and PLAs (programmable logic arrays). DSPs (digital signal processors), FPGAs (field programmable gate arrays), ASICs (application specific integrated circuits), VLSIs (very large scale integrated circuits) or the like.

The many features and advantages of the invention are apparent from the detailed specification, and thus, it is intended by the appended claims to cover all such features and advantages of the invention which fall within the true spirit and scope of the invention.

For example, while I have described the above computer implemented processes with reference to placing a satellite in orbit around the earth at a predetermined inclination, the above described technique is applicable or relevant to any object that requires inclination changes and/or maneuvers to be placed in orbit around the earth or other planet, body in space, and/or effect in space simulating or providing orbit like characteristics. That is, the technique/method described herein may be used regardless of object type and/or inclination change. The technique described herein may be used as a new computer generated route for travel between two points in space. In addition, the above techniques apply in the reverse situation of placing an object in orbit around the moon when the object emanates from the moon or moon orbit. For example, the object may be launched from the moon, travel to the WSB, perform a maneuver and/or inclination change, and then returned to a suitable orbit around the moon.

Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

REFERENCES (incorporated herein by reference)

1. Belbruno, E., “Fast Resonance Shifting as a Mechanism of Dynamic Instability Illustrated by Comets and CHE Trajectories”, Annals of the NY Academy of Sciences, V822, in Near Earth Objects, May 1997.

2. Belbruno, E., Marsden, B., “Resonance Hopping in Comets”, The Astronomical Journal, V 13, n.4, pp 1433-1444, April 1997.

3. Belbruno, E., “A New Method to Determine Ballistic Lunar Capture Transfers Using a Computer Implemented Process”, U.S. Provisional Patent application Ser. No. 60/036,864, Feb. 4, 1997.

4. Penzo, P., “Lunar and Planetary Missions Launched from Geosynchronous Transfer Orbit”, AAS 97-172, Advances in the Astronautical Sciences, V95, Spaceflight Mechanics, 1997.

5. Belbruno, E.; Genta, G., “Low Energy Comet Rendezvous using Resonance Transitions”, Proceedings on the First IAA Symposium on Realistic Near-Term Advanced Scientific Space Missions, International Academy of Astronautics, Torino, June 1996.

6. Kawaguchi, J.; Yamakowa, H.; Uesugi, T.; Matsuo, H.; On Making Use of Lunar and Solar gravity Assists in Lunar-A, Planot-B Missions, Acta. Astr., V35, pp 633-642, 1995.

7. Belbruno, E., “Examples of the Nonlinear Dynamics of Ballistic Capture and Escape in the Earth-Moon System, AIAA Paper 90-2896, Proceedings of the 1990 AIAA Conference in Astrodynamics, August 1990.

8. Naeye, Robert, “Hoppin the Solar System”, Astronomy, page 28, November 1997.

9. Alexeyev, V. M.; Osipov, Yu. S., “Accuracy of Kepler Approximation for Fly-By Orbits Near an Attracting Centre”, Ergod. Th. and Dynam. Sys., v2, 263-300, 1982.

10. Arnold, V. I., Mathematical Methods of Classical Mechanics, Springer-Verlag, GTM Series, no. 60, 1989.

11. Arnold, V. I.; Avez, A., Ergodic Problems of Classical Mechanics, W. A. Benjamin, Inc., New York, 1968.

12. Arnold, V. I., “Instability of Dynamical Systems with Several Degrees of Freedom”, Soviet Mathematics, v5, no3, 581-585, 1964.

13. Belbruno, E.; Marsden, B., “Resonance Hopping In Comets”, Preprint, Submitted for Publication, September 1996.

14. Belbruno, E.; Genta, G., “Low Energy Comet Rendezvous Using Resonance Transitions”, Proc. of First IAA Symposium Missions to the Outer Solar System and Beyond, Torino, Italy, June 1996. (To appear in Acta. Astr.)

15. Belbruno, E., “Visualization of Hop Dynamics in the Three-Body Problem”, Geometry Center Tape no. S-106, April 1995.

16. Belbruno, E., “The Dynamical Mechanism of Ballistic Lunar Capture transfers in the Four-Body Problem from the Perspective of Invariant Manifolds and Hill's regions”, Centre de Recerca Matemàtica, Institute d'Estudis Catalans, Report no. 270, November 1994.

17. Belbruno, E., “Ballistic Lunar Capture Transfers using the Fuzzy Boundary and Solar Perturbations: A Survey”, J. Brit. Inter. Soc., v47, 73-80, 1994.

18. Belbruno, E.; Miller, J., “Sun-Perturbed Earth-to-Moon Transfers with Ballistic Capture”, J. Guid., Control and Dyn., vl6, 73-80, 1993.

19. Belbruno, E., “Examples of the Nonlinear Dynamics of Ballistic Capture and Escape in the Earth-Moon System”, Proc. AIAA Conf. on Astrodynamics, AIAA Paper no. 90-2896, August 1990.

20. Belbruno, E., “Lunar Capture Orbits, A Method of Constructing Earth-Moon Trajectories and the Lunar GAS Mission”, Proceedings 19th AIAA/DGLR/JSASS Inter. Elec. Propl. Conf., AIAA Paper no. 87-1054, Col. Springs, May 1987. 87-1054,

21. Birkhoff, G. D., Dynamical Systems, AMS Coll. Publ., Vol. 9, Pages 290- 291, 1927.

22. Herman, M., Hamiltonian Dynamics and The Ergodic Hypothesis, Notes from Samuel Eilenberg Lectures at Columbia University, Fall 1996.

23. Herman, M., “Stabilitié Topologique des Systèmes Dynamiques Conservatifs”, à paraïtre dans Atas do 18° Col. Bras. Mat., 1992.

24. Frank, A., “Gravity's Rim: Riding Chaos to the Moon”, Discover, 74-79, September 1994.

25. Katok, A.; Berstein, D., “Birkoff Periodic Orbits for Small Perturbations of Completely Integrable Hamiltonian Systems with Convex Hamiltonians”, Invent. Math., v88, 225-241, 1987.

26. Llbre, J.; Martitnez, R.; Simó, C., “Transversality of the Invariant Manifolds Associated to the Lyapunov Family of Periodic Orbits Near L₂ in the Restricted Three-Body Problem”, Diff. Equ., v58, 104-156, 1985.

27. Marsden, B. G., “Kuiper Belt: The New Frontier”, Asteroids, Comets, Meteors 1996, ed. A.-C. Levasseur-Regourd and M. Fulchignoni, In Press.

28. Marsden, B. G., “The Orbit and Ephemeris of Periodic Comet Oterma”, Astron. J., v66, 246-248, 1951.

29. Mather, J. N., “Variational Construction of Connecting Orbits”, Ann. Inst. Fourier, Grenoble, v43, no.5, 1349-1386, 1993.

30. Mather, J. N., “A Criterion for the Non-Existence of Invariant Circles”, Publ. Math. IHES, v63, 153-204, 1982.

31. Moser, J., Stable and Random Motions in Dynamical Systems, Ann. Math. Studies, Vol. 77, Princeton Univ. Press, 1973.

32. Moser, J., “On Invariant Curves of Area-Preserving Mappings of the Annulus”, Nachr. Akad. Wiss. Göttingen, math.-phys. K1, 1-10, 1962.

33. Poincaré, H., Les Méthods Nouvelles de la Méchanique Céleste, Vol. 3, Paris, 1899.

34. Poincaré, H., Les Mé thods Nouvelles de la Méchanique Céleste, Vol. 2, Paris, 1893.

35. Poincaré, H., Les Mé thods Nouvelles de la Méchanique Céleste, Vol. 1, Paris, 1892.

36. Remo, J., “NEO Orbits and Nonlinear Dynamics: A Brief Overview”, Proceedings of the Inter. Near Earth Objects Conf., New York Academy of Sciences, In press.

37. Nekoroshev, N. N., “The Behavior of Hamiltonian systems that are Close to Integrable Ones”, Funct. Analy. and Appl., v5, no.4, 1971.

38. Schwartzschild, K., “Über die Stabilität der Bewegung eines durch Jupiter gefangenen Kometen”, Astr. Nachr., v141, 1-8, 1896.

39. Siegel, C. L.; Moser, J. K., Lectures on Celestial Mechanics, Springer-Verlag, Grundlehren Series, Vol. 187, 1971.

40. Tabacman, E., “Variational Computation of Homoclinic Orbits for Twist Maps”, Phys. D, v85, 548-562, 1995.

1. A method of changing at least one of an inclination and an altitude of a first object including at least one of a space vehicle, satellite and rocket, using a computer implemented and assisted process, comprising the sequential or non-sequential steps of:
(a) generating a first transfer for convergence of first target variables at a first target including at least one of a first planet, first planet orbit and first location in space;
(b) traveling, by the first object, to a vicinity of the first target using the first transfer;
(c) rendezvousing, by the first object, with the first target where a second object including at least one of a second object, second planet, spaceship and comet, has undergone, is undergoing or will undergo a resonant hop or other resonance, said rendezvousing including substantially matching conditions of the second object including velocity;
(d) optionally performing an inclination change at the second object responsive to the second object undergoing the resonant hop or other resonance; and
(e) traveling from the second object to a third target including at least one of a third planet, third planet orbit and third location in space, at a predetermined arbitrary altitude and an optional inclination responsive to said rendezvousing step (c) and said optionally performing step (d).

2. A method according to claim 1, wherein at least one of said generating step (a), said rendezvousing step (c) and performing step (d) are dynamically generated in the first object.

3. A method according to claim 1, wherein at least one of said generating step (a), said rendezvousing step (c) and performing step (d) are dynamically generated in a central controller remote from the first object.

4. A method according to claim 1, wherein at least one of said generating step (a), said rendezvousing step (c) and performing step (d) are generated in the first object.

5. A method according to claim 1, wherein at least one of said generating step (a), said rendezvousing step (c) and performing step (d) are generated in a central controller remote from the first object.

6. A method according to claim 1, wherein said steps (a)-(e) are used in a navigational system to navigate the first object to rendezvous with the first target.

7. A computer program memory, storing computer instructions for changing at least one of an inclination and an altitude of a first object including at least one of a space vehicle, satellite and rocket, using a computer implemented and assisted process executing the computer instructions, the computer instructions and computer assisted process including the sequential or non-sequential functions of:
(a) generating, by the computer instructions, a first transfer for convergence of first target variables at a first target including at least one of a first planet, first planet orbit and first location in space;
(b) traveling, by the first object, to a vicinity of the first target using the first transfer;
(c) rendezvousing, by the first object, with the first target where a second object including at least one of a second object, second planet, spaceship and comet, has undergone, is undergoing or will undergo a resonant hop or other resonance, said rendezvousing including substantially matching conditions of the second object including velocity;
(d) optionally performing, by the computer instructions, an inclination change at the second object responsive to the second object undergoing the resonant hop or other resonance; and
(e) traveling from the second object to a third target including at least one of a third planet, third planet orbit and third location in space, at a predetermined arbitrary altitude and an optional inclination responsive to said rendezvousing step (c) and said optionally performing step (d).

8. A method of a first object including at least one of a space vehicle, satellite and rocket, rendezvousing with a second object including at least one of another object, another space vehicle, another satellite, another rocket, a planet, a planet orbit and a first location in space, using a computer implemented and assisted process, comprising the sequential or non-sequential steps of:
(a) generating a first transfer for convergence of first target variables substantially at the second object;
(b) traveling, by the first object, to a vicinity of the second object using the first transfer;
(c) rendezvousing and transferring, by the first object, with the second object which has undergone, is undergoing or will undergo a resonant hop or other resonance, said rendezvousing including substantially matching conditions of the second object including velocity and resonance, thereby facilitating the efficient use of at least one of fuel, energy and propellant.

9. A method according to claim 8, wherein said rendezvousing step (c) is performed by the first object at a weak stability boundary (WSB) of the second object.

10. A method according to claim 8, wherein said rendezvousing step (c) is performed by the first object at a weak stability boundary (WSB) of the second object comprising a larger planetary body or object than the first object.

11. A method according to claim 8, wherein said rendezvousing step (c) is performed by the first object at a weak stability boundary (WSB) of the second object comprising a larger planetary body or object than the first object, where the first object has a negligible gravitational effect on the second object.

12. A method of a second object ejecting from a first object including at least one of a planet, planetary orbit and first location in space, using a computer implemented and assisted process, comprising the sequential or non-sequential steps of:
(a) generating a first transfer for convergence of first target variables at the first object;
(b) traveling, by the second object, to a vicinity of the first object using the first transfer where the first object has undergone, is undergoing or will undergo a resonant hop or other resonance;
(c) increasing energy of the second object responsive to said traveling step (b) when the first object has undergone or is undergoing the resonant hop or the other resonance;
(d) ejecting, by the second object from the first object using the increased energy responsive to said increasing step (c), thereby facilitating the efficient use of at least one of fuel, energy and propellant of the second object.

13. A method according to claim 12, wherein said traveling step (b) is performed by the second object at a velocity such that the second object is in a weak stability boundary of the first object for ejection therefrom, while facilitating the efficient use of at least one of fuel, energy and propellant of the second object.

14. A method according to claim 12, wherein said traveling step (b) is performed by the second object at a hyperbolic excess velocity such that the second object is in a weak stability boundary of the first object for ejection therefrom, and the second object does not transition into a resonant ellipse.

15. A method according to claim 12, wherein said traveling step (b) is performed by the second object such that the second object settles into an orbit about the Sun reaching an apoapsis of an ellipse about the Sun, substantially at the end of said ejecting step (d).

16. A method according to claim 12, wherein said increasing step (c) increases at least one of the E3 and C3 energy of the second object.

17. A method of a second object being captured by a first object including at least one-of a planet, planetary orbit and first location in space, using a computer implemented and assisted process, comprising the sequential or non-sequential steps of:
(a) generating a first transfer for convergence of first target variables at the first object;
(b) traveling, by the second object, to a vicinity of the first object using the first transfer where the first object has undergone, is undergoing or will undergo a resonant hop or other resonance;
(c) decreasing energy of the second object responsive to said traveling step (b) when the first object has undergone or is undergoing the resonant hop or the other resonance;
(d) capturing, by the first object the second object via the decreased energy responsive to said decreasing step (c), thereby facilitating the efficient use of at least one of fuel, energy and propellant of the second object.

18. A method according to claim 17, wherein said traveling step (b) is performed by the second object at a velocity such that the second object is in a weak stability boundary of the first object for capture thereby, while facilitating the efficient use of at least one of fuel, energy and propellant of the second object.

19. A method according to claim 17, wherein said traveling step (b) is performed by the second object at a hyperbolic excess velocity such that the second object is in a weak stability boundary of the first object for capture thereby, and the second object does not transition into a resonant ellipse.

20. A method according to claim 17, wherein said decreasing step (c) decreases at least one of the E3 and C3 energy of the second object.

21. A method of placing a satellite into orbit around the earth and optionally changing at least one of an inclination and an altitude of the satellite, using a computer implemented process, comprising the sequential or non-sequential steps of:
(a) traveling, by the satellite, from the earth or the earth orbit to a weak lunar capture in the WSB or the WSB orbit at a first target including at least one of a first planet, first planet orbit and first location in space;
(b) traveling, by the satellite, to a vicinity of the first target;
(c) rendezvousing, by the satellite with the first target where the first target has undergone, is undergoing or will undergo a resonant hop or other resonance, said rendezvousing including substantially matching conditions of the first target by the satellite including velocity;
(d) optionally performing, by the satellite, at least one substantially negligible maneuver or maneuver, and optionally performing an inclination change at the WSB or the WSB orbit; and
(e) traveling, by the satellite, from the WSB or the WSB orbit to the earth or the earth orbit at a predetermined arbitrary altitude and optionally at the inclination change, responsive to said rendezvousing step (c) and said optionally performing step (d).

22. A method of a first object including at least one of a space vehicle, satellite and rocket, rendezvousing with a second object including at least one of another object, another space vehicle, another satellite, another rocket, a planet, a planet orbit and a first location in space, using a computer implemented and assisted process, comprising the sequential or non-sequential steps of:
(a) traveling, by the first object, to a vicinity of the second object; and
(b) rendezvousing and transferring, by the first object, with the second object which has undergone, is undergoing or will undergo a resonant hop or other resonance, said rendezvousing including substantially matching conditions of the second object including velocity and resonance, thereby facilitating the efficient use of at least one of fuel, energy and propellant.
